(19) United States
(12) Patent Application Publication
(10) Pub. No.: US 2025/0135813 A1
(43) Pub. Date: May 1, 2025

(54) WORKING MACHINE

(71) Applicant: KUBOTA CORPORATION, Osaka (JP)

(72) Inventors: Yuji FUKUDA, Sakai-shi (JP); Ryota HAMAMOTO, Sakai-shi (JP)

(21) Appl. No.: 18/386,105

(22) Filed: Nov. 1, 2023

(51) Int. Cl. B60D 1/64; B60D 1/24

(52) U.S. Cl. CPC B60D 1/64; B60D 1/246

(57) ABSTRACT

A working vehicle includes a hitch, operation switch(es) to be operated to attach/detach the attachment to/from the hitch, a receiver to receive a signal from a transmitter in/on the attachment, and a controller to perform a process based on the identification information in the signal. The hitch includes a latching mechanism operable in a latching state and an unlatching state, and a latch actuator to actuate the latching mechanism while the operation switch(es) is being operated. The controller is configured or programmed to, when the operation switch(es) is operated continuously for a first period or more or a second period or more, determine that the attachment is allowed to be detached or is attached and start the process, the first period being time taken for the latching mechanism to switch to the unlatching state, the second period being time taken for the latching mechanism to switch to the latching state.

### BACKGROUND OF THE INVENTION

### 1. Field of the Invention

The present invention relates to a technique to use an attachment attached to a working vehicle.

### 2. Description of the Related Art

The specification of U.S. Patent Application Publication No. 2022/412040 discloses a system to automatically identify one of the attachments at the site that is attached to a working vehicle. The system is such that a first communication unit (tool module) including a first acceleration sensor is provided on an attachment such as a bucket, a quick changer configured to quickly and simply attach and detach the attachment thereto and therefrom is provided at the distal end of the boom of the working vehicle (excavator), a second communication unit (receiving module) including a second acceleration sensor is provided at the quick changer, and the working vehicle is provided with an identification module and a controller.

The first communication unit transmits, to the second communication unit via a near field communication such as RFID or Bluetooth (registered trademark) Low Energy, a first acceleration signal relating to the instantaneous acceleration of the attachment detected by the first acceleration sensor and an identifying signal of the attachment. The second communication unit transmits, to the identification module, the first acceleration signal and the identifying signal received from the first communication unit and the second acceleration signal relating to the instantaneous acceleration of the quick changer detected by the second acceleration sensor. The identification module identifies the attachment attached to the quick changer based on, for example, the difference between the first acceleration signal and the second acceleration signal received from the second communication unit. The controller controls operation of the working vehicle based on the identifying signal received from the identification module.

In the case where an attachment is to be attached to or allowed to be detached from the working vehicle via a linkage such as a quick changer, the operator of the working vehicle operates a manual operator to actuate the working device and the linkage. In order to have the linkage completely actuated, it is necessary to drive an actuator such as a hydraulic cylinder or an electric motor for a certain period of time or more. Therefore, if the actuator is not actuated for a certain period of time or more, the attachment is not brought into a state in which the attachment is actually attached to the working vehicle or a state in which the attachment is allowed to be detached from the working vehicle, resulting in the possibility that the actual state of the attachment (actually attached or actually allowed to be detached) may differ from the state of the attachment (attached or allowed to be detached) electrically detected by an electronic device such as an identification module form the received signal.

Preferred embodiments of the present invention make it possible to eliminate or reduce the likelihood that the actual state of the attachment (actually attached to or actually allowed to be detached from the working vehicle) will differ from the electrically detected state of the attachment (attached or allowed to be detached).

### SUMMARY OF THE INVENTION

A working vehicle according to one or more preferred embodiments of the present invention includes a hitch to attach and detach an attachment thereto and therefrom, at least one operation switch to be operated to attach or detach the attachment to or from the hitch, a receiver to receive a wireless signal which is transmitted periodically from a transmitter in or on the attachment, which includes identification information of the attachment, and which is compliant with a near field communication standard, and a controller to perform a predetermined process based on the identification information included in the wireless signal received by the receiver, wherein the hitch includes a latching mechanism operable selectively in a latching state in which the attachment is secured to the hitch and an unlatching state in which the attachment is not secured to the hitch, and a latch actuator to actuate the latching mechanism between the latching state and the unlatching state while the at least one operation switch is being operated, and the controller is configured or programmed to, when the at least one operation switch is operated continuously for a first predetermined period or more or for a second predetermined period or more, determine that the attachment is allowed to be detached from the hitch or is attached to the hitch and start the predetermined process, the first predetermined period being a period of time taken for the latching mechanism to switch from the latching state to the unlatching state, the second predetermined period being a period of time taken for the latching mechanism to switch from the unlatching state to the latching state.

The at least one operation switch may include a detaching switch to be operated to allow the attachment to be detached from the hitch. The controller may be configured or programmed to, when the detaching switch is operated continuously for the first predetermined period or more, determine that the attachment is allowed to be detached from the hitch and start a without-attachment predetermined process as the predetermined process, the without-attachment predetermined process being a process based on a precondition that the working vehicle is provided with no attachments.

The at least one operation switch may include an attaching switch to be operated to attach the attachment to the hitch. The controller may be configured or programmed to, when the attaching switch is operated continuously for the second predetermined period or more, determine that the attachment indicated by the identification information included in the wireless signal received by the receiver is attached to the hitch and start a with-attachment predetermined process as the predetermined process, the with-attachment predetermined process being a process based on a precondition that the working vehicle is provided with the attachment.

The controller may be configured or programmed to, when the attachment is attached to the hitch and the controller is performing the with-attachment predetermined process, if the detaching switch is operated and a duration of operation of the detaching switch is less than the first predetermined period, continue to perform the with-attachment predetermined process or stop the with-attachment predetermined process temporarily and then resume the with-attachment predetermined process.

The controller may be configured or programmed to, when the attachment is attached to the hitch and the controller is performing the with-attachment predetermined process, if the attaching switch is operated, continue to perform the with-attachment predetermined process.

The controller may be configured or programmed to, when the attachment is attached to the hitch and the controller is performing the with-attachment predetermined process, if the detaching switch is operated continuously for the first predetermined period or more and then the attaching switch instead of the detaching switch starts to be operated within a third predetermined period and is operated continuously for the second predetermined period or more, continue to perform the with-attachment predetermined process or stop the with-attachment predetermined process temporarily and then resume the with-attachment predetermined process.

The controller may be configured or programmed to, if the attaching switch is operated continuously for the second predetermined period or more after the controller has determined that the attachment is allowed to be detached, read identification information included in a wireless signal received by the receiver after a fourth predetermined period after the controller has determined that the attachment is allowed to be detached and determine that an attachment indicated by the identification information is attached to the hitch.

The controller may be configured or programmed to perform, as the without-attachment predetermined process, a process to cause a user interface to output information indicating that the attachment is allowed to be detached. The controller may be configured or programmed to perform, as the with-attachment predetermined process, a process to cause a user interface to output information indicating that the attachment is attached.

The working vehicle may further include a first memory to store one or more pieces of control data set for respective one or more of the attachments. The controller may be configured or programmed to start, as the with-attachment predetermined process, a process including reading, from the first memory, one of the one or more pieces of control data that corresponds to one of the one or more attachments that is attached to the hitch and controlling output of power to the one of the one or more attachments based on the read one of the one or more pieces of control data.

The working vehicle may include the detaching switch and the attaching switch. The controller may be configured or programmed to, when the detaching switch is operated continuously for the first predetermined period or more and a first actuation period has passed since a start of operation of the detaching switch, determine that the attachment is allowed to be detached from the hitch and start the without-attachment predetermined process, and when the attaching switch is operated continuously for the second predetermined period or more and a second actuation period has passed since a start of operation of the attaching switch, determine that the attachment is attached to the hitch and start the with-attachment predetermined process.

The working vehicle may further include a prime mover, and a second memory. The controller may be configured or programmed to, upon determining that the attachment is attached to the hitch, identify the attachment based on the identification information included in the wireless signal transmitted from the transmitter in or on the attachment and received by the receiver and cause the second memory to store a result of identification of the attachment, and if the prime mover is temporarily stopped and then is restarted with the attachment attached to the hitch, start the with-attachment predetermined process corresponding to the result of identification of the attachment stored in the second memory.

The controller may be configured or programmed to, if the prime mover is temporarily stopped and then is restarted with the attachment attached to the hitch, cause a user interface to output the result of identification of the attachment stored in the second memory.

The working vehicle may further include an auxiliary mode switch to be operated to start an auxiliary mode in which a specific attachment is allowed to be used, a power outlet port through which power is outputted to the specific attachment, and an auxiliary output switch to be operated to transmit power to the power outlet port. The controller may be configured or programmed to, if the controller determines that the attachment attached to the hitch is the specific attachment while the prime mover is being actuated and the auxiliary mode is being performed, output power to the specific attachment through the power outlet port in response to operation of the auxiliary output switch, and when the prime mover is stopped temporarily and then restarted with the attachment attached to the hitch, if the result of identification of the attachment stored in the second memory indicates the specific attachment, output, after the auxiliary mode is started in response to operation of the auxiliary mode switch, power to the specific attachment through the power outlet port in response to operation of the auxiliary output switch.

The controller may be configured or programmed to, if the controller determines that the attachment is allowed to be detached from the hitch, delete the result of identification of the attachment from the second memory.

The working vehicle may further include a third memory to store a first set period which is equal to or longer than the first predetermined period and a second set period which is equal to or longer than the second predetermined period. The controller may be configured or programmed to, when the at least one operation switch is operated continuously for the first set period or more or for the second set period or more, determine that the attachment is allowed to be detached from the hitch or is attached to the hitch and start the predetermined process.

The transmitter may be a beacon transmitter to transmit an advertisement signal including identification information of the attachment in or on which the transmitter is provided. The receiver may be a beacon scanner to receive the advertisement signal.

An attachment usage system according to one or more preferred embodiments of the present invention includes a hitch to attach and detach an attachment thereto and therefrom, the hitch being provided on a working vehicle, at least one operation switch to be operated to attach or detach the attachment to or from the hitch, a receiver to receive a wireless signal which is transmitted periodically from a transmitter in or on the attachment, which includes identification information of the attachment, and which is compliant with a near field communication standard, and a controller to perform a predetermined process based on the identification information included in the wireless signal received by the receiver, wherein the hitch includes a latching mechanism operable selectively in a latching state in which the attachment is secured to the hitch and an unlatching state in which the attachment is not secured to the hitch, and a latch actuator to actuate the latching mechanism between the latching state and the unlatching state while the at least one operation switch is being operated, and the controller is configured or programmed to, when the at least one operation switch is operated continuously for a first predetermined period or more or for a second predetermined period or more, determine that the attachment is allowed to be detached from the hitch or is attached to the hitch and start the predetermined process, the first predetermined period being a period of time taken for the latching mechanism to switch from the latching state to the unlatching state, the second predetermined period being a period of time taken for the latching mechanism to switch from the unlatching state to the latching state.

The above and other elements, features, steps, characteristics and advantages of the present invention will become more apparent from the following detailed description of the preferred embodiments with reference to the attached drawings.

### BRIEF DESCRIPTION OF THE DRAWINGS

A more complete appreciation of preferred embodiments of the present invention and many of the attendant advantages thereof will be readily obtained as the same becomes better understood by reference to the following detailed description when considered in connection with the accompanying drawings described below.

FIG. 1 is a block diagram of an attachment usage system and a working vehicle.

FIG. 2 is a diagram showing an example of information included in an advertisement signal.

FIG. 3 is a diagram showing an example of the relationship between attachment IDs and their corresponding pieces of display data.

FIG. 4 is a diagram showing an example of the relationship between attachment IDs and their corresponding pieces of control data.

FIG. 5 is a flowchart showing an example of an attachment information collecting process.

FIG. 6 is a diagram showing an example of information stored in an internal memory of a controller.

FIG. 7 is a state diagram illustrating a state in which an attachment is attached and a state in which the attachment is allowed to be detached.

FIG. 8 is a flowchart showing an example of an attachment mounting process.

FIG. 9A illustrates an example of an “attachment is attached” screen.

FIG. 9B illustrates an example of an “attachment is not yet attached” screen.

FIG. 9C illustrates another example of an “attachment is attached” screen.

FIG. 9D illustrates a further example of an “attachment is attached” screen.

FIG. 9E illustrates an example in which a control corresponding to the attachment was started on the “attachment is attached” screen.

FIG. 10 is a screen showing an example of an attachment list.

FIG. 11 is a flowchart showing an example of an attachment releasing process.

FIG. 12A illustrates an example of an “attachment is allowed to be detached” screen.

FIG. 12B illustrates another example of an “attachment is attached” screen.

FIG. 12C illustrates another example of an “attachment is allowed to be detached” screen.

FIG. 13 is a flowchart showing another example of an attachment mounting process.

FIG. 14A is a flowchart shoring a further example of an attachment mounting process.

FIG. 14B is a flowchart showing another example of an attachment releasing process.

FIG. 15 is a flowchart showing an example of an attachment identification process performed when restarting a prime mover.

FIG. 16 illustrates an example of an auxiliary mode screen.

FIG. 17A illustrates an example of a control map of a first set period and a second set period.

FIG. 17B illustrates another example of a control map of a first set period and a second set period.

FIG. 17C illustrates a further example of a control map of a first set period and a second set period.

FIG. 18 is a side view of a working vehicle.

FIG. 19 is an elevational view of a quick hitch.

FIG. 20A is a side view of an attachment unlatched by a quick hitch.

FIG. 20B is a side view of an attachment latched by a quick hitch.

### DETAILED DESCRIPTION OF THE PREFERRED EMBODIMENTS

The preferred embodiments will now be described with reference to the accompanying drawings, wherein like reference numerals designate corresponding or identical elements throughout the various drawings. The drawings are to be viewed in an orientation in which the reference numerals are viewed correctly.

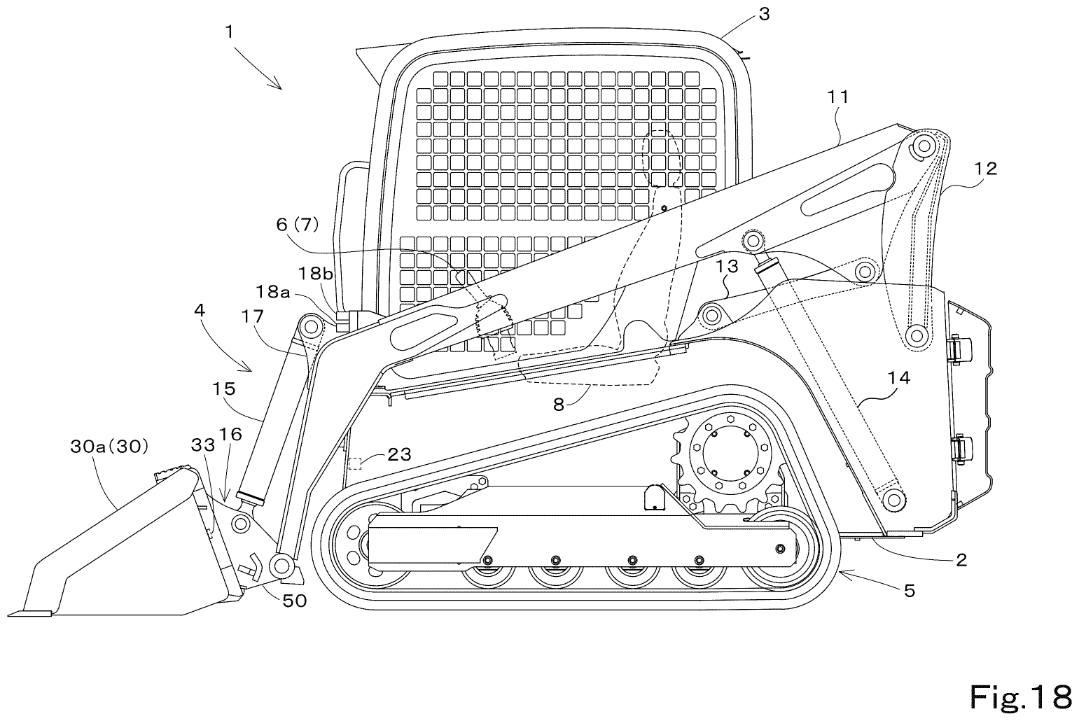

FIG. 18 is a side view of a working vehicle 1 according to the present preferred embodiment. In the present preferred embodiment, a compact track loader is discussed as an example of the working vehicle 1. Note, however, that the working vehicle according to a preferred embodiment of the present invention is not limited to a compact track loader, and may be, for example, some other construction machine or agricultural machine such as a skid-steer loader, a backhoe, or a tractor.

The working vehicle 1 includes a machine body 2, a cabin 3, a working device 4, and traveling device(s) 5. The cabin 3 is provided on the machine body 2. The cabin 3 includes an operator's seat 8, operation members (manual operators) to be operated by an operator seated on the operator's seat 8, and/or the like. The operation members include a travel operation member 6 to operate the traveling devices 5 and a work operation member 7 to operate the working device 4.

The traveling devices 5 are provided on the left and right sides of the machine body 2 and support the machine body 2 such that the machine body 2 is allowed to travel. The traveling devices 5 are crawler traveling devices. The operator operates the travel operation member 6 to cause both the left and right traveling devices 5 to rotate in a forward direction, both the left and right traveling devices 5 to rotate in a reverse direction, only one of the left and right traveling devices 5 to rotate in the forward direction, or one of the left and right traveling devices 5 to rotate in the forward direction and the other to rotate in the reverse direction to cause the machine body 2 (working vehicle 1) to travel forward, rearward, or turn left or right.

The working device 4 is attached to the machine body 2. The working device 4 includes a bucket 30a, boom(s) 11, lift link(s) 12, control link(s) 13, boom cylinder(s) 14, front cylinder(s) 15, and a quick hitch 16. The booms 11, the lift links 12, the control links 13, the boom cylinders 14, and the front cylinders 15 are provided at the left and right of the cabin 3. The left and right booms 11 are connected to each other by a connector 17 at an intermediate portion of their front portion. The left boom 11 has, at the front portion thereof, a hydraulic fluid outlet port (power output port) 18a and a hydraulic fluid inlet port 18b.

The lift links 12 and the control links 13 support proximal portions (rear portions) of the booms 11 via shafts such that the booms 11 are swingable up and down. The boom cylinders 14 each have one end thereof pivotally connected to a corresponding one of the booms 11 via a shaft and the other end thereof pivotally connected to a lower rear portion of the machine body 2 via a shaft. Upon operation of the work operation member 7 along a first direction by the operator of the working vehicle 1, the boom cylinders 14 extend or retract and the booms 11 ascend or descend (swing upward or downward).

The booms 11 are provided with the quick hitch 16 at the distal ends thereof. The quick hitch 16 is a linkage configured to easily attach and detach any of various attachments (hydraulic driven working tools) 30 such as the bucket 30a. The operator of the working vehicle 1 can easily change attachments 30 using the quick hitch 16. The quick hitch 16 is therefore also called “quick changer”. In the example shown in FIG. 18, the bucket 30a which is an example of the attachment 30 is attached to a front portion of the quick hitch 16.

The quick hitch 16 has, connected to a rear portion thereof, the distal ends of the booms 11 and ends of the front cylinders 15 via respective shafts such that the booms 11 and the front cylinders 15 are pivotable. The opposite ends of the front cylinders 15 are pivotally connected to the connector 17 via shafts. Upon operation of the work operation member 7, the front cylinders 15 extend or retract and the quick hitch 16 swings upward or rearward. With this, the bucket 30a attached to the quick hitch 16, swinging upward or downward, performs shoveling or dumping.

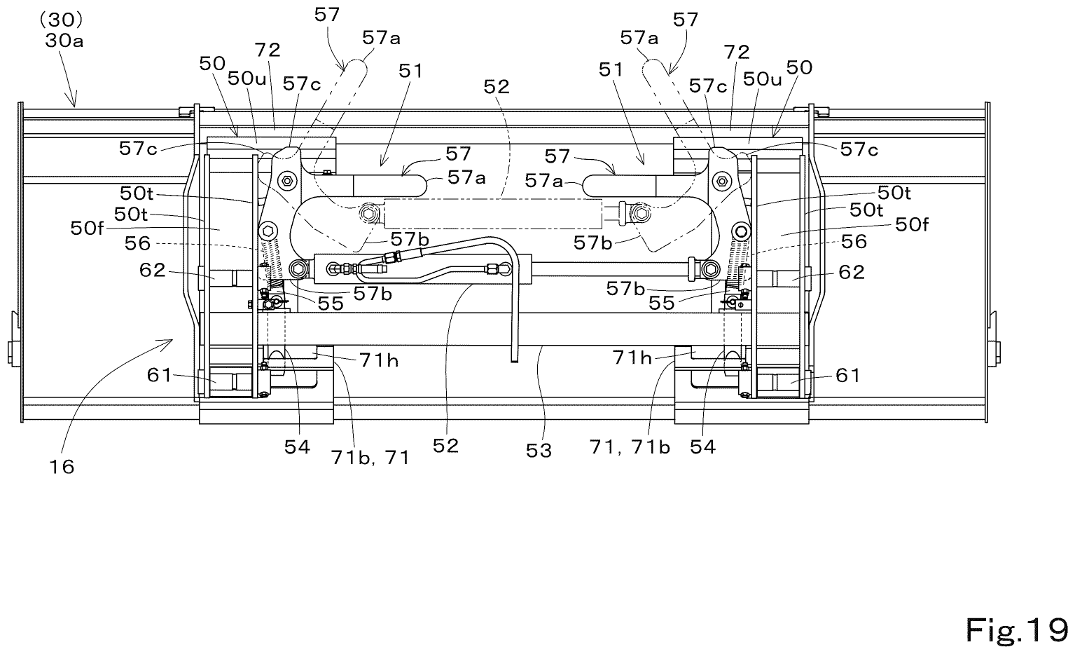

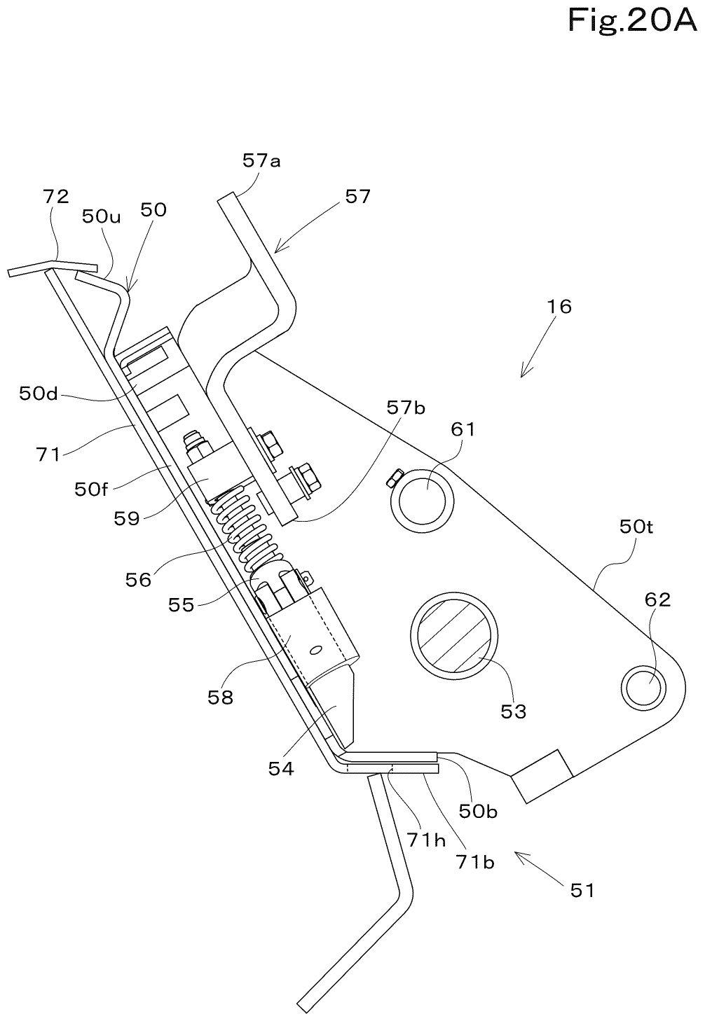

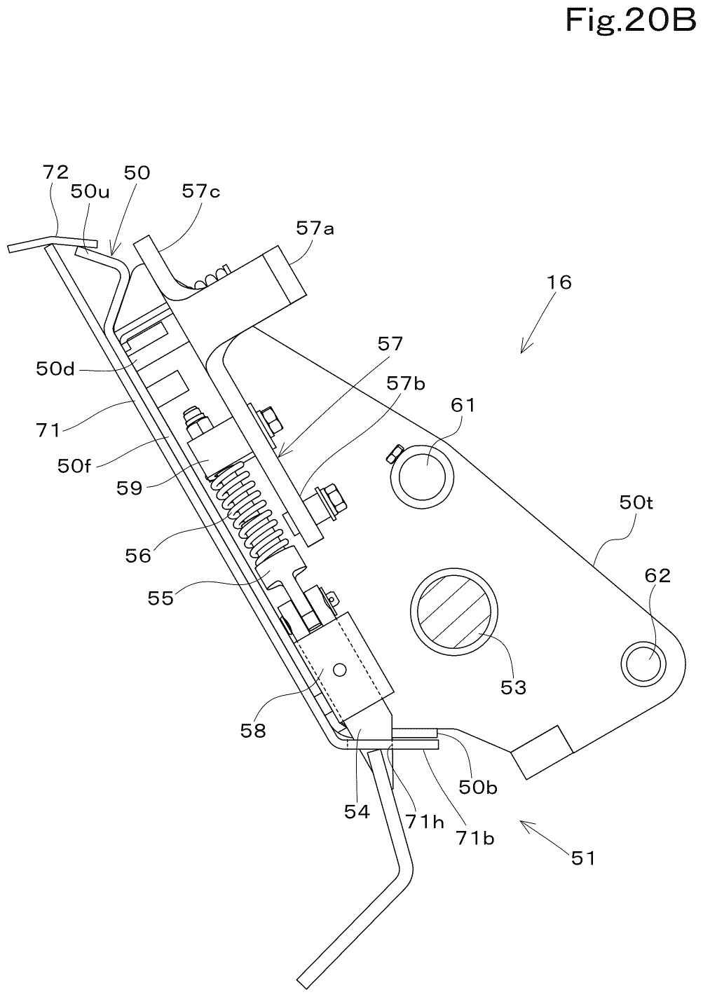

FIG. 19 is an elevational view of the quick hitch 16. Specifically, FIG. 19 illustrates the quick hitch 16 in FIG. 18 as viewed from the machine body 2 of the working vehicle 1. FIG. 20A is a side view of an attachment 30 unlatched by the quick hitch 16. FIG. 20B is a side view of the attachment 30 latched by the quick hitch 16.

The quick hitch 16 includes a pair of left and right brackets 50, a pair of left and right latching mechanisms 51, a latch cylinder 52, and the like. The brackets 50 hold the attachment 30. The latching mechanisms 51 are selectively operable in a latching state in which the attachment 30 is secured to the brackets 50 (quick hitch 16) or an unlatching state in which the attachment 30 is allowed to be detached from the brackets 50. The latch cylinder 52 is a latch actuator to place the latching mechanisms 51 selectively in the latching state or the unlatching state.

As illustrated in FIG. 20A, each of the brackets 50 includes a front plate 50f and a pair of connector plates 50t projecting rearward from the front plate 50f. The connector plates 50t have pivotally connected thereto the distal ends of the left and right booms 11 (FIG. 18) via shafts 61, and have pivotally connected thereto ends of the left and right front cylinders 15 (FIG. 18) via shafts 62. The connector plates 50t are connected to a beam 53, so that the pair of brackets 50 are combined.

The front plate 50f of each of the brackets 50 includes an upper portion 50u bent in the form of the letter V as illustrated in FIG. 20A. The front plate 50f includes a lower portion 50b bent such that the lower portion 50b projects diagonally rearward. A top plate 72 bent downward is provided above a base plate 71 of the attachment 30. The base plate 71 includes a lower portion 71b bent such that the lower portion 71b projects diagonally rearward. The lower portion 71b of the base plate 71 has a through-hole 71h.

The upper portions 50u of the front plates 50f of the brackets 50 are inserted into the gap between the base plate 71 and the top plate 72 of the attachment 30 and engage with the back surface of the top plate 72, the front surfaces of the front plates 50f engage with the base plate 71, and the lower portions 50b of the front plates 50f engage with the lower portion 71b of the base plate 71. With this, the attachment 30 is held by the brackets 50.

The latching mechanisms 51 are located inward of the connector plates 50t of the brackets 50 in FIG. 19. Each of the latching mechanisms 51 includes, as illustrated in FIG. 20A, a latch pin 54, a link 55, a coil spring 56, a latch lever 57, and the like. The latch pin 54 is held by a housing 58 fixed to a corresponding bracket 50 such that the latch pin 54 is movable up and down. The latch pin 54 includes a lower portion projecting downward from the housing 58, and the lower portion has an inclined surface sloping diagonally forward and downward. The latch pin 54 includes an upper portion rotatably connected to a lower end portion of the link 55 via pin(s). The link 55 is inserted in the coil spring 56. The link 55 includes an upper end portion projecting from the coil spring 56, and the upper end portion is held by a holder 59.

Each latch lever 57 is substantially in the form of the letter L as illustrated in FIG. 19. The latch lever 57 includes a bent intermediate portion which is rotatably connected to a mount 50d on a corresponding bracket 50 via pin(s) as illustrated in FIG. 20A. The latch lever 57 includes a first projecting portion 57a which projects inward from corresponding connector plates 50t as illustrated in FIG. 19. The latch lever 57 includes a second projecting portion 57b projecting downward. The second projecting portion 57b has, connected to a back surface of a central portion thereof, the holder 59 via pin(s) as illustrated in FIG. 20A. The latch lever 57 includes a third projecting portion 57c which projects upward as illustrated in FIG. 19.

The latch cylinder 52 is a hydraulic cylinder which is positioned laterally and located above the beam 53. The latch cylinder 52 has a first end (distal end of the rod) pivotally connected to the distal end portion of the second projecting portion 57b of one of the latch levers 57 (right latch lever 57 in FIG. 19) via pin(s). The latch cylinder 52 has a second end (bottom of the cylinder case) pivotally connected to the distal end portion of the second projecting portion 57b of the other of the latch levers 57 (the left latch lever 57 in FIG. 19) via pin(s).

The retraction of the latch cylinder 52, as indicated by dot-dot-dash lines in FIG. 19, causes the second projecting portions 57b of the left and right latch levers 57 to approach each other, causing the latch levers 57 to pivot upward. Then, as illustrated in FIG. 20A, the links 55 and the latch pins 54 move upward and the latch pins 54 detach from the through-holes 71h in the base plate 71 of the attachment 30.

With this, the latching mechanisms 51 are placed in their unlatching state in which the latching mechanisms 51 do not hold the attachment 30, allowing the attachment 30 to be detached from the quick hitch 16. The third projecting portions 57c of the latch levers 57 contact corresponding connector plates 50t of the brackets 50, so that the degree of retraction of the latch cylinder 52, the angle of upward rotation of the latch levers 57, and the degree of upward movement of the latch pins 54 are restricted.

Upon the extension of the latch cylinder 52 as indicated by solid lines in FIG. 19 from the state as illustrated in FIG. 20A, the second projecting portions 57b of the left and right latch levers 57 are pushed to cause the latch levers 57 to pivot downward. Upon such pivoting, the holders 59 cause the links 55 and the latch pins 54 to move downward and compress the coil springs 56. Then, as illustrated in FIG. 20B, the latch pins 54 are inserted in the through-holes 71h in the base plate 71 of the attachment 30, so that the inclined surfaces of the latch pins 54 contact the side walls of the through-holes 71h.

With this, the latching mechanisms 51 are placed in their latching state in which the latching mechanisms 51 hold the attachment 30, and the attachment 30 is attached to the quick hitch 16. The second projecting portions 57b of the latch levers 57 contact corresponding connector plates 50t of the brackets 50, so that the degree of extension of the latch cylinder 52, the angle of downward rotation of the latch levers 57, and the degree of downward movement of the latch pins 54 are restricted. It is noted here that the spring back force of the coil springs 56 holds the latch levers 57 in position. Since the first projecting portions 57a of the latch levers 57 are positioned horizontally, the operator seated on the operator's seat 8 of the working vehicle 1 confirms that the attachment 30 is attached to the quick hitch 16 (working vehicle 1) by looking at the horizontally positioned first projecting portions 57a.

Starting from the state as illustrated in FIG. 18 in which the bucket 30a is attached to the quick hitch 16, the bucket 30a is detached and another attachment 30 is attached to the quick hitch 16. This makes it possible to perform work other than excavation (or some other excavation work) using the other attachment 30. Examples of attachments 30 other than the bucket 30a include pallet forks, skid cutters, crushers, breakers, angle brooms, earth augers, grapple, sweepers, mowers, snow blowers, spreaders, and rakes. Attachments 30 of each type may have different specifications such as sizes and/or shapes.

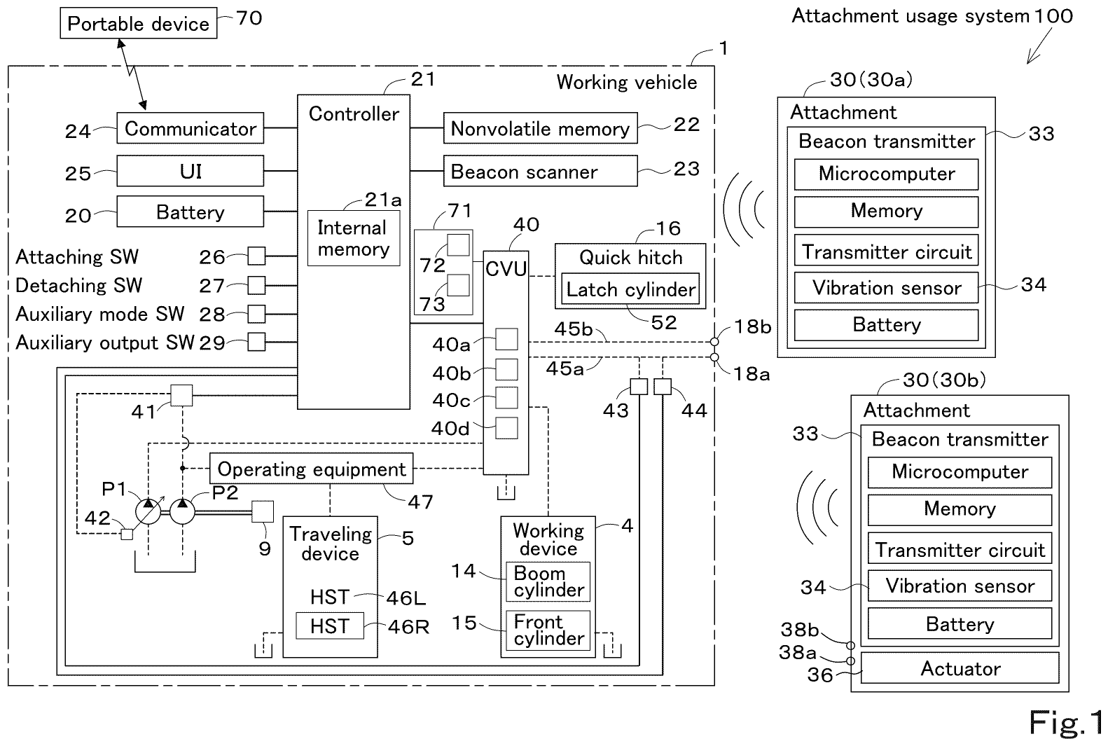

FIG. 1 is a block diagram of an attachment usage system 100 and the working vehicle 1 according to the present preferred embodiment. The attachment usage system 100 includes the working vehicle(s) 1 and attachment(s) 30. The example in FIG. 1 includes one working vehicle 1 and two attachments 30, but the number of working vehicles 1 and the number of attachments 30 included in the attachment usage system 100 may be selected appropriately.

The working vehicle 1 includes a controller 21, one or more nonvolatile memories 22, a beacon scanner 23, a communicator 24, a user interface (indicated as “UI” in FIG. 1) 25, a battery 20, switches (each indicated as “SW” in FIGS. 1) 26 to 29, and/or the like. The controller 21 includes a processor or a computer, which includes a CPU, one or more memories, and/or the like. The controller 21 controls elements of the working vehicle 1. The controller 21 includes an internal memory 21a which is a volatile memory or a nonvolatile memory. The controller 21 may, for example, use a predetermined storage area of the internal memory 21a which is a volatile memory as a buffer for temporary storage of information and data.

The one or more nonvolatile memories 22 are provided externally to the controller 21. The internal memory 21a and the nonvolatile memory 22 store software program(s) and control data for the controller 21 to control operation of the elements. The nonvolatile memory 22 stores pieces of control data corresponding to various attachments 30.

The beacon scanner 23 is a receiver to receive wireless signals (beacon signals) compliant with Bluetooth (registered trademark) Low Energy which is a near field communication standard. The beacon scanner 23 measures the received signal strength indicator (RSSI, received signal strength) of the received wireless signals.

The communicator 24 communicates with a portable device 70 via the Internet or wireless LAN. The portable device 70 is a smartphone, a tablet computer, and/or the like. The user interface 25 includes, for example, a touchscreen (touch panel) and/or the like. For another example, the user interface 25 may include an input and an output provided independently of each other.

The battery 20 supplies electricity to electric equipment in and/or on the working vehicle 1. The attaching switch 26, the detaching switch 27, the auxiliary mode switch 28, and the auxiliary output switch 29 are respective operation switches to be operated by the operator of the working vehicle 1. The attaching switch 26 and the detaching switch 27 are momentary operation switches. The user interface 25 and the switches 26 to 29 are provided operably in the vicinity of the operator's seat 8 in the cabin 3.

The attaching switch 26 is operated to attach the attachment 30 to the quick hitch 16. The detaching switch 27 is operated to allow the attachment 30 to be detached from the quick hitch 16. The auxiliary mode switch 28 is operated to start an auxiliary mode in which specific attachment(s) 30 are usable. The auxiliary output switch 29 is operated to supply hydraulic fluid as power to the hydraulic fluid outlet port 18a. That is, the hydraulic fluid outlet port 18a is a power outlet port.

The working vehicle 1 includes, as hydraulic-related features, a main pump P1, a pilot pump P2, a control valve unit (indicated as “CVU” in FIG. 1) 40, a proportional valve 41, a regulator 42, sensors 43 and 44, hydraulic actuators 14, 15, 46L, 46R, and 52, fluid passage(s), a tank, and/or the like. The main pump P1 and the pilot pump P2 are driven by power from a prime mover 9 to deliver hydraulic fluid sucked from the tank to fluid passage(s). The prime mover 9 includes, for example, an engine. For another example, the prime mover 9 may include an electric motor.

The main pump P1 is a variable displacement hydraulic pump. The regulator 42 changes the angle of the swash plate of the main pump P1. The controller 21 controls the opening of the proportional valve 41 to apply pilot pressure, which is the hydraulic pressure of hydraulic fluid delivered by the pilot pump P2, to the regulator 42. The controller 21 then actuates the regulator 42 to change the angle of the swash plate of the main pump P1 to change the amount of hydraulic fluid delivered by the main pump P1. Operating equipment 47 includes the travel operation member 6 and work operation member 7, operating valves corresponding to the travel operation member 6 and the work operation member 7, switching valve(s), and the like.

The control valve unit 40 allows hydraulic fluid supplied from the main pump P1 through fluid passage(s) to flow to the boom cylinders 14 and the front cylinders 15 of the working device 4, the latch cylinder 52 of the quick hitch 16, and the hydraulic fluid outlet port 18a. The control valve unit 40 also allows hydraulic fluid that flows from the boom cylinders 14, the front cylinders 15, the latch cylinder 52, and the hydraulic fluid inlet port 18b (return fluid) to be discharged. The control valve unit 40 controls the direction and amount of supply of hydraulic fluid to the boom cylinders 14, the front cylinders 15, and the latch cylinder 52. The control valve unit 40 also controls the amount of supply of hydraulic fluid to the hydraulic fluid outlet port 18a.

Specifically, the control valve unit 40 includes control valves 40a, 40b, 40c, and 40d corresponding to the boom cylinders 14, the front cylinders 15, the latch cylinder 52, and the ports 18a and 18b. Each of the control valves 40a, 40b, 40c, and 40d is switchable between a neutral position, a first position, and a second position. At least the control valves 40c and 40d the control valves 40a, 40b, 40c, and 40d are electrically actuated. The control valves 40a, 40b, 40c, and 40d are normally held in the neutral position by the elastic force of a spring.

The operating valve(s) of the operating equipment 47 and/or the like that correspond to the work operation member 7 are actuated according to the manner in which the work operation member 7 is operated, thus allowing the pilot pressure of pilot fluid from the pilot pump P2 to act on pressure receiver(s) of the control valve(s) 40a and/or 40b. With this, the control valve(s) 40a and/or 40b is/are switched from the neutral position to the first position or the second position, so that hydraulic fluid from the main pump P1 is supplied through the control valve(s) 40a and/or 40b to the boom cylinders 14 and/or the front cylinders 15 to cause the boom cylinders 14 and/or the front cylinders 15 to extend or retract. It follows that the booms 11 and/or the attachment 30 such as the bucket 30a attached to the quick hitch 16 swing.

While the attaching switch 26 is being operated, the controller 21 places the control valve 40c in the first position to allow hydraulic fluid from the main pump P1 to be supplied to the latch cylinder 52 in the first direction to cause the latch cylinder 52 to extend. Accordingly, the operation of the attaching switch 26 that lasts for a second predetermined period Ta or more while the latching mechanisms 51 are in the unlatching state causes the latch cylinder 52 to extend to the predetermined degree or more, bringing the latching mechanisms 51 into the latching state. Even if the attaching switch 26 is operated, provided that the operation only lasts for a period less than the second predetermined period Ta, the latch cylinder 52 does not extend to the predetermined degree or more and therefore the latching mechanisms 51 are not brought into the latching state. Therefore, the latching mechanisms 51 are moved back by the spring back force of the coil springs 56 to the original unlatching state.

On the contrary, while the detaching switch 27 is being operated, the controller 21 places the control valve 40c in the second position to allow hydraulic fluid from the main pump P1 to be supplied to the latch cylinder 52 in a second direction opposite to the first direction to cause the latch cylinder 52 to retract. Accordingly, the operation of the detaching switch 27 that lasts for a first predetermined period Tb or more while the latching mechanisms 51 are in the latching state causes the latch cylinder 52 to retract to a predetermined degree or more, bringing the latching mechanisms 51 into the unlatching state. Even if the detaching switch 27 is operated, provided that the operation only lasts for a period less than the first predetermined period Tb, the latch cylinder 52 does not retract to the predetermined degree or more and therefore the latching mechanisms 51 are not brought into the unlatching state. Therefore, the latching mechanisms 51 are moved back by the spring back force of the coil springs 56 to the original latching state.

The second predetermined period Ta and the first predetermined period Tb are each, for example, about 2 to 3 seconds. The second predetermined period Ta and the first predetermined period Tb may be the same period or different periods. The specific values of the second predetermined period Ta and the first predetermined period Tb are examples, and not limited to the values above. The same applies to a third predetermined period Tc, a fourth predetermined period Td, a reception waiting period Tw, a given period Tf, a second actuation period Twa, a first actuation period Twb, a first set period Tb1, and a second set period Ta2 (described later).

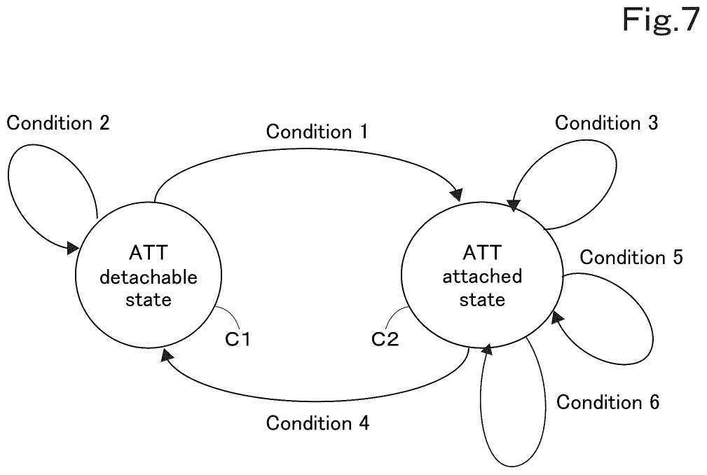

FIG. 7 is a state diagram describing conditions of operation based on which the controller 21 determines whether the attachment 30 is allowed to be detached or is attached. As discussed earlier, each latching mechanism 51 transitions from the latching state to the unlatching state or from the unlatching state to the latching state depending on the conditions of the time for which the attaching switch 26 or the detaching switch 27 is operated. Thus, the controller 21 determines whether or not the attachment 30 is attached based on the time for which the attaching switch 26 and/or the detaching switch 27 has/have been operated.

Specifically, when the detaching switch 27 is operated continuously for a first predetermined period Tb (a period of time taken for the latching mechanism 51 to switch from the latching state to the unlatching state) or more, the controller 21 determines that the attachment 30 is allowed to be detached from the hitch. When the attaching switch 26 is operated continuously for a second predetermined period Ta (a period of time taken for the latching mechanism 51 to switch from the unlatching state to the latching state) or more, the controller 21 determines that the attachment is attached to the hitch. That is, the controller 21 determines whether the latching mechanism 51 is in an attachment detachable state C1 in which the latching mechanism 51 unlatches the attachment 30 or an attachment attached state C2 in which the latching mechanism 51 latches the attachment 30, based on the conditions of operation of the attaching switch 26 and the detaching switch 27.

When the attaching switch 26 is operated continuously for the second predetermined period Ta or more (condition 1) when the latching mechanism 51 is in the unlatching state (i.e., attachment detachable state C1), the latching mechanism 51 is actuated and brought into the latching state, thus transitioning to the attachment attached state C2. On the contrary, even if the attaching switch 26 is operated, provided that the duration of the operation of the attaching switch 26 is less than the second predetermined period Ta (condition 2), the latching mechanism 51 may be actuated but is held by the elastic force of the coil spring 56 in the unlatching state, and therefore does not switch to the latching state and is kept in the attachment detachable state C1.

When the latching mechanism 51 is in the attachment attached state C2, even if the attaching switch 26 is operated (condition 3), the latching mechanism 51 is not actuated. Therefore, the latching mechanism 51 stays in the attachment attached state C2.

When the latching mechanism 51 is in the latching state (i.e., the attachment attached state C2), even if the detaching switch 27 is operated, provided that the duration of the operation of the detaching switch 27 is less than the first predetermined period Tb (condition 5), the latching mechanism 51 may be actuated but is held by the elastic force of the coil spring 56 in the latching state, and therefore does not switch to the unlatching state and is kept in the attachment attached state C2.

While the latching mechanism 51 is in the latching state (i.e., in the attachment attached state C2), when the detaching switch 27 is operated continuously for the first predetermined period Tb or more (condition 4), the latching mechanism 51 is actuated and brought into the unlatching state. However, there may be cases in which, immediately after the latching mechanism 51 is brought into the unlatching state, the operator operates the attaching switch 26 to latch the attachment 30 to the latching mechanism 51 again. To address such cases, it is necessary to take into consideration how much time has passed between the end of the continuous operation of the detaching switch 27 for the first predetermined period Tb or more and the start of the operation of the attaching switch 26. In view of this, condition 6 in FIG. 7 is provided. The manner in which the latching mechanism 51 is actuated when the condition 6 is satisfied will be discussed later in detail.

When the auxiliary mode switch 28 is operated, the auxiliary mode is entered. When the auxiliary mode is selected, a specific attachment 30 is attached to the quick hitch 16. Next, for example, the driver (operator) connects the hydraulic fluid outlet port 18a and a hydraulic fluid inlet port 38b of the specific attachment 30b together using a hose, and connects the hydraulic fluid inlet port 18b and a hydraulic fluid outlet port 38a of the specific attachment 30b together using a hose. Upon operation of the auxiliary output switch 29 under such circumstances, the controller 21 switches the control valve 40d from the neutral position to the first position or the second position. With this, hydraulic fluid from the main pump P1 is supplied (transmitted) through a fluid passage 45a to the hydraulic fluid outlet port 18a, and hydraulic fluid flowing into a fluid passage 45b from the hydraulic fluid inlet port 18b is drained through the control valve unit 40.

Furthermore, hydraulic fluid discharged through the hydraulic fluid outlet port 18a is introduced into the specific attachment 30b through the hydraulic fluid inlet port 38b via a hose or the like. Furthermore, hydraulic fluid (return fluid) discharged through the hydraulic fluid outlet port 38a of the specific attachment 30b is introduced through the hydraulic fluid inlet port 18b via a hose or the like and is drained from the control valve unit 40. Since hydraulic fluid is introduced and discharged to and from the specific attachment 30b as such, hydraulic actuators 36 such as a hydraulic motor and/or hydraulic cylinder(s) of the attachment 30b are actuated, making it possible to perform work using the attachment 30b.

When allowing hydraulic fluid to be introduced and discharged to and from the specific attachment 30b, the controller 21 changes the opening of the control valve 40d depending on what specific attachment 30b is attached to the quick hitch 16, to adjust the flow rate or hydraulic pressure of hydraulic fluid supplied to the hydraulic fluid outlet port 18a. For example, the controller 21 may cause the flow rate sensor 43 to detect the flow rate of hydraulic fluid flowing through the fluid passage 45a and control the opening of the control valve 40d. Additionally or alternatively, the controller 21 may cause the pressure sensor 44 to detect the hydraulic pressure of hydraulic pressure flowing through the fluid passage 45a and control the opening of the control valve 40d.

The pair of left and right traveling devices 5 include a pair of left and right hydro-static transmissions (HSTs) 46L and 46R corresponding to the pair of left and right traveling devices 5. Each of the HSTs 46L and 46R includes hydraulic pump(s) and a travel motor (hydraulic motor).

The operating valve(s) of the operating equipment 47 and/or the like that correspond to the travel operation member 6 are actuated according to the manner in which the travel operation member 6 is operated, thus changing the angle of inclination of the swash plate(s) of the hydraulic pump(s) of the HST(s) 46L and/or 46R. This controls the supply, the stopping of supply, and the direction of supply of hydraulic fluid from the hydraulic pump(s) of the HSTs 46L and/or 46R to the travel motor(s), the travel motor(s) rotate(s) in the forward direction, rotate in the reverse direction, or stop, the left and/or right traveling device(s) 5 also rotate(s) in the forward direction, rotate in the reverse direction, or stop, and the working vehicle 1 travels forward, rearward, turn left or right, or stops.

Furthermore, switching valve(s) for speed changes of the operating equipment 47 and/or like switch(es) positions according to control signal(s) from the controller 21, thus changing the angle of inclination of the swash plate(s) of the travel motor(s) of the HSTs 46L and/or 46R. With this, the rotation speed of the travel motor(s) increases or decreases, so that the travel speed of the traveling devices 5 and the working vehicle 1 is changed.

The attachment 30 attachable to the working vehicle 1 is provided with a beacon transmitter 33. The beacon transmitter 33 is a transmitter to periodically transmit an advertisement signal (also called “advertisement packet” or “beacon signal”) which is a wireless signal compliant with Bluetooth (registered trademark) Low Energy. The beacon transmitter 33 looks like a small tag, and is therefore sometimes called a “BLE tag”. The beacon transmitter 33 includes a microcomputer, a memory, a transmitter circuit, a battery, a vibration sensor 34, and/or the like. The elements of the beacon transmitter 33 are driven by electricity from the battery. The beacon transmitter 33 transmits the advertisement signal at interval(s) of, for example, about 1 second to about 3 seconds, but the intervals are not limited to 1 second to 3 seconds and may be selected as appropriate.

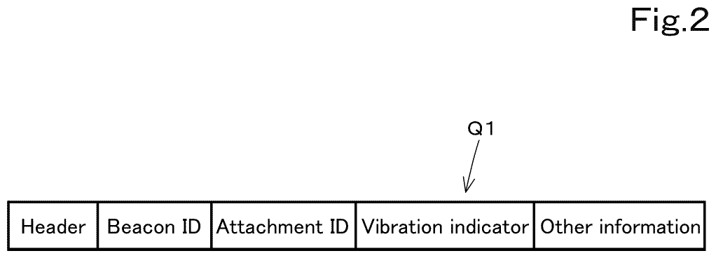

FIG. 2 shows an example of information contained in an advertisement signal Q1 transmitted from the beacon transmitter 33. The advertisement signal Q1 includes a header, a beacon ID, an attachment ID, a vibration indicator, and/or the like. The beacon ID is identification information of the beacon transmitter 33 which is the sender of the advertisement signal Q1. The attachment ID is identification information of the attachment 30 in or on which the beacon transmitter 33 which is the sender of the advertisement signal Q1 is provided.

The vibration indicator is an indicator indicating the magnitude of vibration detected by the vibration sensor 34 of the beacon transmitter 33 which is the sender of the advertisement signal Q1. That is, the vibration sensor 34 detects the vibration of the attachment 30 on which the beacon transmitter 33 (sender of the advertisement signal Q1) is provided, the microcomputer calculates a vibration indicator indicating the magnitude of the vibration, and the vibration indicator is included into the advertisement signal Q1. The vibration indicator indicates, for example, at least one of the displacement, velocity, or acceleration of vibration of the attachment 30 detected by the vibration sensor 34. An acceleration sensor may be used as the vibration sensor 34.

As illustrated in FIG. 18, the beacon transmitter 33 is located on, for example, the back surface of the attachment 30 that faces the machine body 2 of the working vehicle 1. The beacon scanner 23 is located at, for example, the front portion of the machine body 2 that faces the attachment 30. The controller 21 is provided in the machine body 2. Since the beacon scanner 23 is provided in or on the machine body 2, it is possible to achieve a configuration in which output signals from the beacon scanner 23 can be inputted into the controller 21 using simple electric wiring or simple communication circuit(s) as compared to cases where the beacon scanner 23 is provided on the movable working device 4.

The advertisement signal Q1 transmitted from the beacon transmitter 33 is received by the beacon scanner 23 of the working vehicle 1. The controller 21 recognizes (identifies) the attachment 30 based on the attachment ID included in the advertisement signal Q1 received by the beacon scanner 23.

In the case where a plurality of attachments 30 are present in the vicinity of the working vehicle 1, advertisement signal(s) Q1 from beacon transmitters 33 of the attachments 30 are received by the beacon scanner 23. Upon receipt of each advertisement signal Q1, the beacon scanner 23 measures the RSSI of the advertisement signal Q1. The controller 21 selects one of the advertisement signal(s) Q1 received by the beacon scanner 23, based on the RSSI(s) measured by the beacon scanner 23 at the receipt of that advertisement signal(s) Q1. The controller 21 then identifies the attachment 30 attached to the quick hitch 16 based on the attachment ID included in the selected advertisement signal Q1.

It is considered that one of the advertisement signals Q1 received by the beacon scanner 23 that has the highest RSSI is a signal transmitted from the beacon transmitter 33 located closest to the beacon scanner 23 and including the ID of the attachment 30 attached to the quick hitch 16. Therefore, for example, the controller 21 determines the highest one of the RSSIs of the advertisement signals Q1 received by the beacon scanner 23, and identifies the attachment 30 attached to the quick hitch 16 based on the attachment ID included in the advertisement signal Q1 that corresponds to the highest RSSI.

The controller 21, upon identifying the attachment 30 attached to the quick hitch 16, starts a predetermined process for cases where an attachment is attached (with-attachment predetermined process) which is a process that corresponds to the identified attachment 30 and that is based on the precondition that the working vehicle 1 is provided with the attachment 30. Specifically, an example of the predetermined process is a control in which the controller 21 causes the user interface 25 to output (display) information indicating that the identified attachment 30 is attached. Another example of the predetermined process for cases where an attachment is attached (with-attachment predetermined process) is a control in which the controller 21 controls output of hydraulic fluid (power) to the attachment 30 (controls start and stop of the supply of hydraulic fluid to the attachment 30) according to the identified attachment 30. It is noted here that the controller 21 may also control at least one of the introduction of hydraulic fluid from the attachment 30, the amount of hydraulic fluid supplied to the attachment 30, or the pressure of hydraulic fluid supplied to the attachment 30.

With the attachment usage system 100, an automatic selection mode or a manual selection mode can be selected by, for example, an administrator performing a predetermined operation on the user interface 25. The automatic selection mode is a mode in which the controller 21 automatically identifies the attachment 30 attached to the quick hitch 16. The manual selection mode is a mode in which the controller 21 identifies the attachment 30 attached to the quick hitch 16 based on information entered on the user interface 25. The administrator switches between the automatic selection mode and the manual selection mode in response to a request from, for example, the operator of the working vehicle 1.

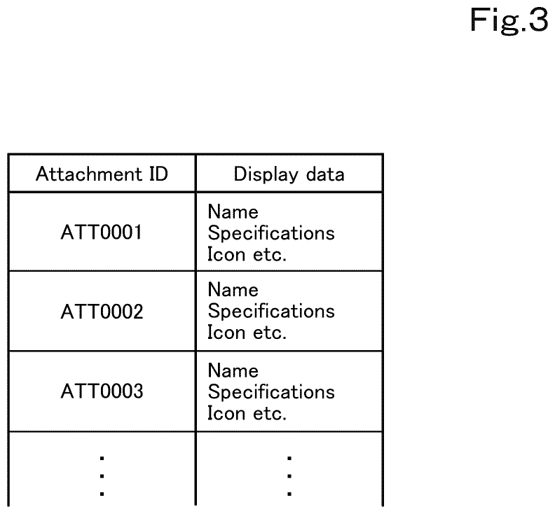

Display data and control data are preset for each of attachments 30 attachable to the quick hitch 16. FIG. 3 is a table showing an example of the relationship between the attachment IDs of the attachments 30 attachable to the quick hitch 16 and pieces of display data corresponding to the attachments 30. A piece of display data is data based on which the user interface 25 displays information about a corresponding attachment 30. The display data includes, for example, an icon, name, and specifications of the corresponding attachment 30. Such an attachment ID and display data of the attachment 30 are stored in a predetermined storage area of the nonvolatile memory 22 such that the attachment ID and the display data of the attachment 30 are associated with each other. Note that display data other than that described above may be stored in the nonvolatile memory 22 such that the display data is associated with the attachment ID.

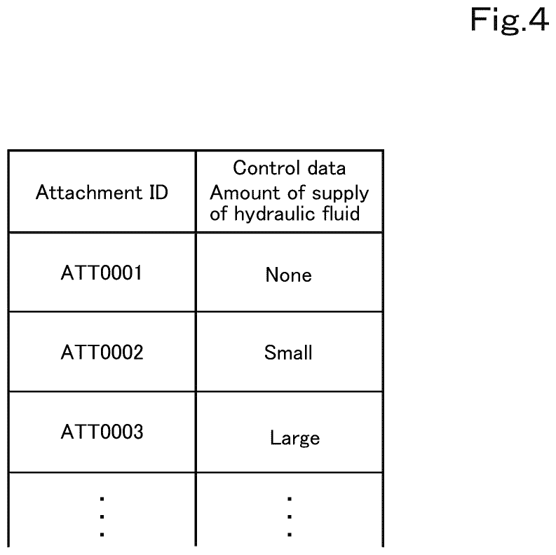

FIG. 4 is a table showing an example of the relationship between the attachment IDs of the attachments 30 attachable to the quick hitch 16 and pieces of control data corresponding to the attachments 30. A piece of control data indicates control performed by the working vehicle 1 according to what attachment 30 is used. The control data includes, for example, the level of the amount of hydraulic fluid supplied to the corresponding attachment 30. Such an attachment ID and control data of the attachment 30 are stored in a predetermined storage area of the nonvolatile memory 22 such that the attachment ID and the control data of the attachment 30 are associated with each other. Note that other control data, such as the level of hydraulic pressure outputted to the attachment 30 and/or the output value of power other than hydraulic fluid, may be stored in the nonvolatile memory 22 such that the control data is associated with the attachment ID.

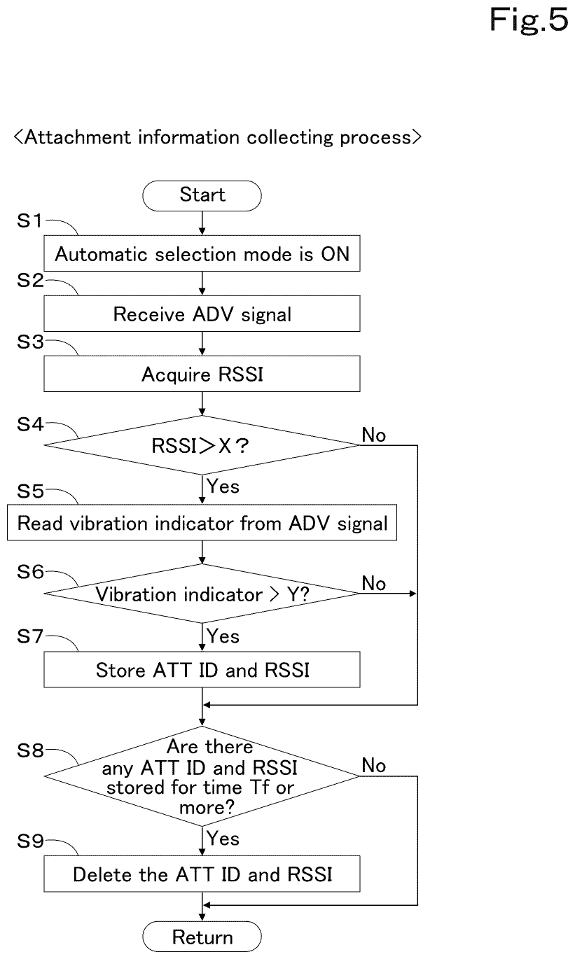

FIG. 5 is a flowchart showing an example of an attachment information collecting process. The attachment information collecting process is performed by the controller 21 of the working vehicle 1 based on software program(s) stored in the internal memory 21a or the nonvolatile memory 22. The same applies to an attachment mounting process and an attachment releasing process (described later). In FIG. 5, the advertisement signal Q1 is referred to as “ADV signal” and the attachment is referred to as “ATT” for convenience of description. The same applies to FIGS. 7, 8, 11, 13, 14A, 14B, and 15 (described later).

In the case where the automatic selection mode is selected (S1 in FIG. 5), upon receipt of an advertisement signal Q1 from the beacon transmitter 33 by the beacon scanner 23 (S2), the controller 21 acquires the RSSI of the advertisement signal Q1 from the beacon scanner 23 (S3). Next, if the acquired RSSI is greater than a predetermined value (first predetermined value) X (YES in S4), the controller 21 reads a vibration indicator from the received advertisement signal Q1 (S5).

Next, if the read vibration indicator is greater than a predetermined value (second predetermined value) Y (YES in S6), the controller 21 causes the internal memory 21a to store the attachment ID included in the received advertisement signal Q1 and the RSSI of the advertisement signal Q1 such that the attachment ID and the RSSI are associated with each other (S7). It is noted here that the controller 21 causes the internal memory 21a to also store, for example, information relating to the time at which the attachment ID and the RSSI were stored (such as a timestamp) such that the information is associated with the attachment ID and the RSSI. The controller 21 may cause the internal memory 21a to also store, for example, a beacon ID and/or other information included in the received advertisement signal Q1 such that the beacon ID and/or the other information are associated with the attachment ID and the RSSI.

In contrast, if the RSSI of the received advertisement signal Q1 is equal to or less than the predetermined value X (NO in S4), the controller 21 does not cause the internal memory 21a to store the attachment ID included in the received advertisement signal Q1 or the RSSI of the advertisement signal Q1. Also if the vibration indicator included in the received advertisement signal Q1 is equal to or less than the predetermined value Y (NO in S6), the controller 21 does not cause the internal memory 21a to store the attachment ID included in the received advertisement signal Q1 or the RSSI of the advertisement signal Q1.

If any of the attachment ID(s) or RSSI(s) in the internal memory 21a has been stored for a given period Tf or more (YES in S8), the controller 21 deletes that attachment ID(s) and RSSI(s) from the internal memory 21a (S9). It is noted here that the controller 21 also deletes other information (such as time information) corresponding to the attachment ID(s) having been stored for the given period Tf or more. The given period Tf is, for example, about 30 seconds which corresponds to at least one of the time for an attachment 30 to be attached to the working vehicle 1 or the time for the attachment 30 to be replaced with another one. After step S9, the controller 21 repeats step S1 and subsequent steps.

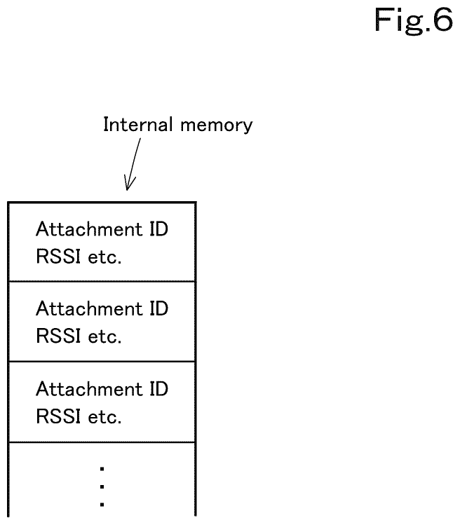

FIG. 6 shows information stored in the internal memory 21a of the controller 21. The controller 21 repeats the attachment information collecting process shown in FIG. 5, so that attachment IDs and their corresponding RSSIs are collected in the internal memory 21a as shown in FIG. 6. Specifically, the controller 21 selects one of the advertisement signal(s) Q1 that is received by the beacon scanner 23 from the beacon transmitter 33 on the attachment 30 which is located close to the quick hitch 16 (working vehicle 1) to some extent and which has vibrated when attached to the quick hitch 16. The attachment ID included in the selected advertisement signal Q1 and the RSSI of that advertisement signal Q1 are stored (collected) in the internal memory 21a of the controller 21 for the given period Tf. For another example, the controller 21 may cause the nonvolatile memory 22 to store the attachment ID and the RSSI of the advertisement signal Q1 for the given period Tf.

When an attachment 30 placed on the ground or the like is to be attached to the working vehicle 1, the operator of the working vehicle 1 operates the traveling device 5 and/or the working device 4 using the operation member(s) 6 and/or 7 to allow the front plates 50f of the brackets 50 of the quick hitch 16 to engage with the base plate 71 of the attachment 30, thus holding the attachment 30 with the brackets 50 (see FIG. 20A). In so doing, in some cases, the operator allows the front plates 50f to engage with the base plate 71 and then allow the booms 11 and/or the quick hitch 16 to swing upward by a predetermined angle using the work operation member 7 to raise the attachment 30 with the working device 4 to some extent to check whether the attachment 30 is held by the brackets 50.

Then, if the operator operates the attaching switch 26 for the second predetermined period Ta or more, the controller 21 causes the latch cylinder 52 to extend. With this, the latch levers 57 pivot downward, so that the latch pins 54 are inserted into the through-holes 71h of the base plate 71 of the attachment 30 to allow the attachment 30 to be latched by the latching mechanisms 51 (see FIG. 20B). That is, the attachment 30 is brought into an attachment attached state in which it is attached to the quick hitch 16 and the working vehicle 1 (C2 in FIG. 7). During the steps of attaching the attachment 30 described above, the attachment 30 vibrates, for example, when the front plates 50f of the brackets 50 are brought into engagement with the base plate 71 of the attachment 30, when the attachment 30 is raised by the working device 4, and/or when the attachment 30 is latched by the latching mechanisms 51.

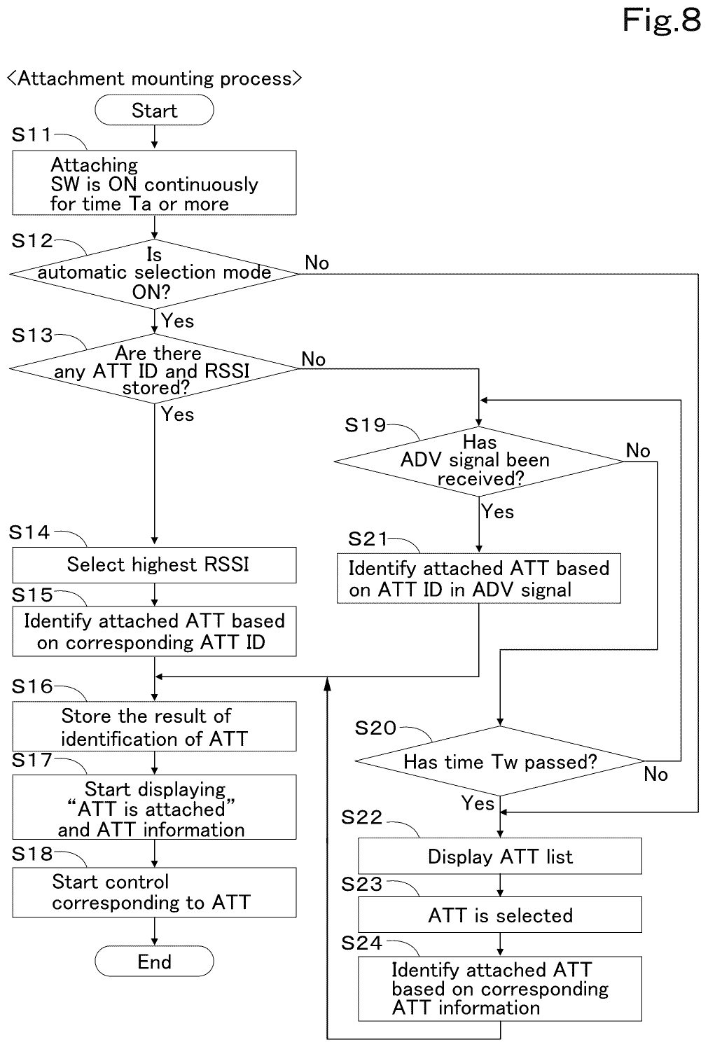

FIG. 8 is a flowchart showing an example of the attachment mounting process. If the attaching switch 26 is operated continuously (continues to be in ON state) for a second predetermined period Ta or more (S11 in FIG. 7) as described earlier (condition 1 in FIG. 7), the controller 21 determines that the attachment 30 is in the attachment attached state C2 in which the quick hitch 16 is in the latching state and the attachment 30 is attached to (secured to) the quick hitch 16 (S11 in FIG. 8). Next, in the case where the automatic selection mode is selected (YES in S12), the controller 21 determines whether or not any attachment IDs are stored in the internal memory 21a.

If the internal memory 21a stores one or more attachment IDs therein (YES in S13), the internal memory 21a also stores one or more RSSIs corresponding to the one or more attachment IDs therein. Therefore, the controller 21 reads the one or more RSSIs stored in the internal memory 21a, and selects the highest one of the RSSIs (S14).

Next, the controller 21 reads the attachment ID that corresponds to the highest RSSI from the internal memory 21a, and identifies the attachment 30 attached to the quick hitch 16 based on the attachment ID (S15). That is, the controller 21 regards, as the ID of the attachment 30 attached to the quick hitch 16, the attachment ID included in the advertisement signal Q1 received from the beacon transmitter 33 located closest to the beacon scanner 23. The controller 21 then identifies the type, other specifications, and/or the like of the attachment 30 attached to the quick hitch 16 based on the selected attachment ID.

Note that the RSSIs stored in the internal memory 21a may include one or more highest RSSIs. If a plurality of the highest RSSIs are stored in the internal memory 21a, such RSSIs have the same value and correspond to the same attachment ID. Therefore, the controller 21 may identify the attachment 30 attached to the quick hitch 16 based on the same attachment ID.

Next, the controller 21 causes the nonvolatile memory 22 to store the result of identification of the attachment 30 (S16). It is noted here that the controller 21 causes the nonvolatile memory 22 to store information indicating that the identified attachment 30 is attached to the quick hitch 16, i.e., to the working vehicle 1, and the attachment ID of the attached attachment 30.

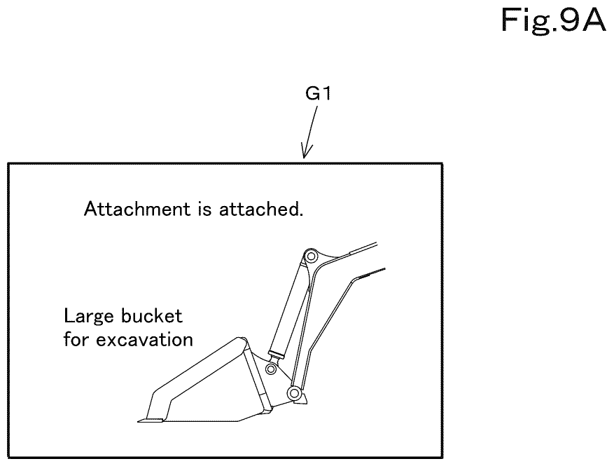

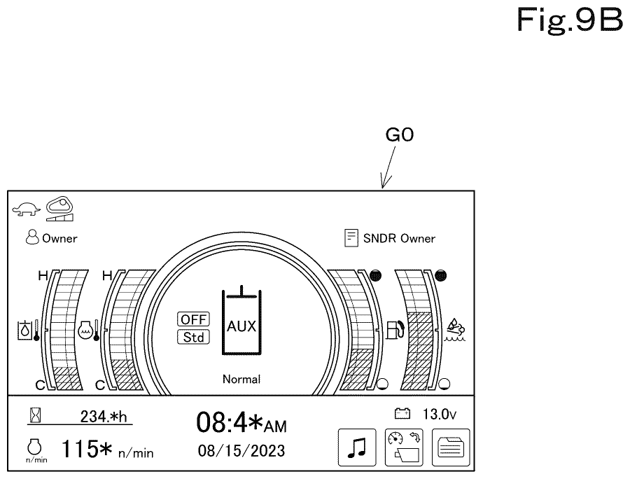

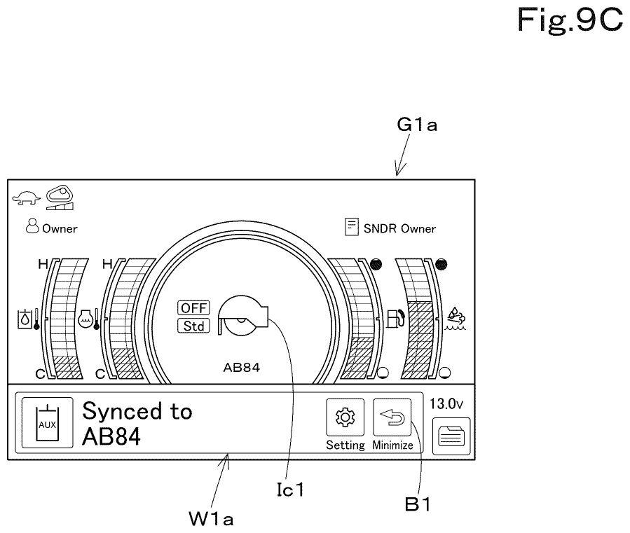

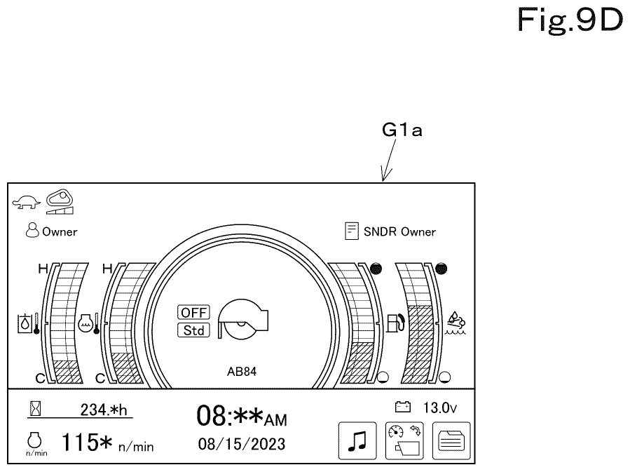

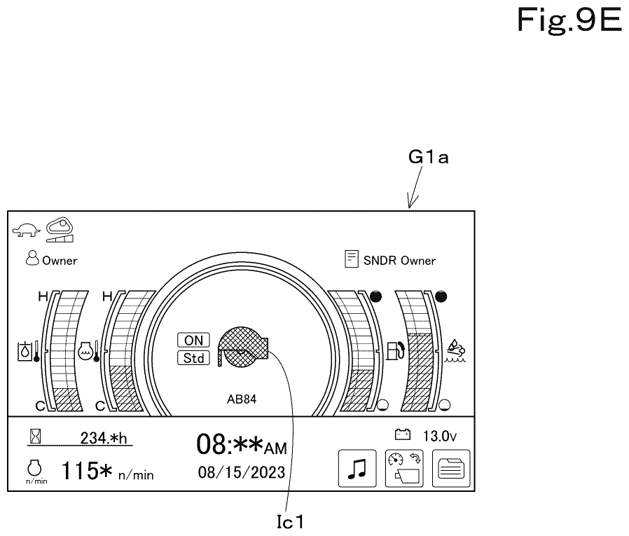

The controller 21 starts a display control in which the controller 21 causes the user interface 25 to display (output) attachment information which indicates that the attachment 30 is attached and which indicates the attached attachment 30, as the predetermined process for cases where an attachment is attached (with-attachment predetermined process) (S17). It is noted here that, for example, the controller 21 causes the user interface 25 to display an “attachment is attached” screen G1 as illustrated in FIG. 9A.

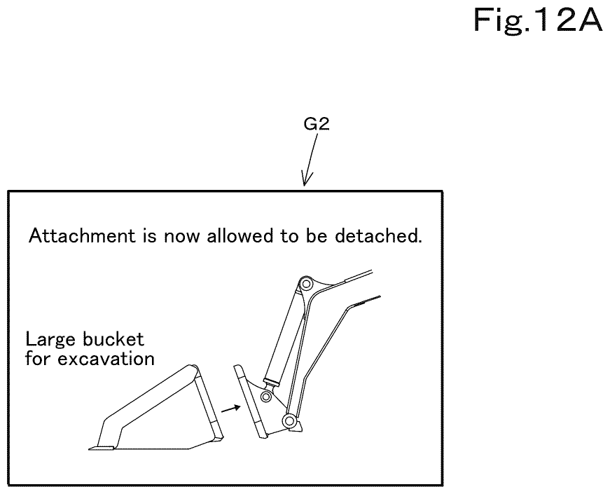

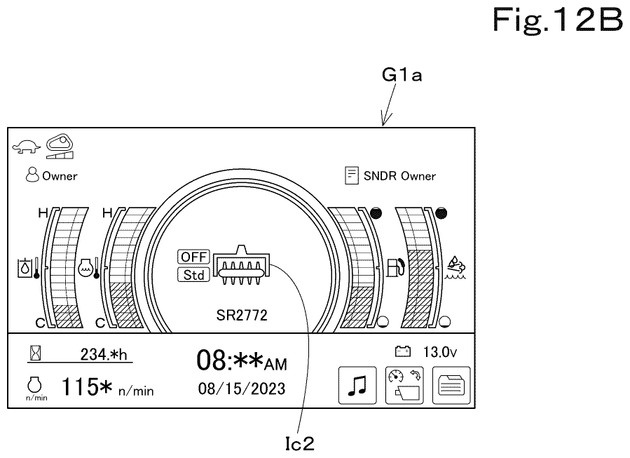

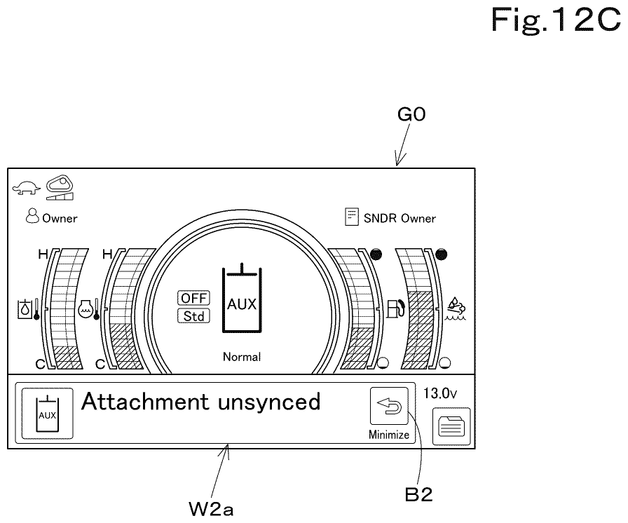

The “attachment is attached” screen G1 as illustrated in FIG. 9A displays a message indicating that the attachment 30 is attached, the attachment information relating to the attached attachment 30, and an icon of the attachment 30. In the example in FIG. 9, the attachment information “Large bucket” “for excavation” is displayed. Additionally or alternatively, other attachment information such as the size and/or manufacturer of the attachment 30 may be displayed (the same applies to FIG. 12 described later). The display data for the “attachment is attached” screen G1 and the attachment information are prestored in the nonvolatile memory 22.

For another example, the controller 21 may cause the communicator 24 (FIG. 1) to transmit, to the portable device 70, the display data for the “attachment is attached” screen G1 and the attachment information of the attachment 30 which has been identified as being attached so that the “attachment is attached” screen G1 is displayed on a display of the portable device 70.

The controller 21 reads control data corresponding to the attachment 30 identified as being attached to the quick hitch 16 from the nonvolatile memory 22, and starts a control corresponding to the attachment 30 based on the control data, as the predetermined process for cases where an attachment is attached (with-attachment predetermined process) (S18 in FIG. 8). It is noted here that, in the case where the attachment 30 identified as being attached to the quick hitch 16 is an attachment 30b including a hydraulic actuator 36 such as a skid cutter or an angle broom, the controller 21 starts causing the control valve 40d to control the output of hydraulic fluid from the hydraulic fluid outlet port 18a to the attachment 30b, based on the read control data. With this, draining of return fluid to be introduced from the attachment 30b into the hydraulic fluid inlet port 18b is also started. The controller 21 may, for example, cause the “attachment is attached” screen G1 to display a message indicating that the control of the output of hydraulic fluid to the attachment 30b has been started.

Another example of a display control which is an example of the predetermined process for cases where an attachment is attached (with-attachment predetermined process) is a control in which the controller 21 causes the user interface 25 to display a screen as illustrated in FIG. 9B, 9C, 9D, or 9E. FIG. 9B is an example of an “attachment 30 is not yet attached” screen G0. The controller 21 causes the user interface 25 to display the “attachment is not yet attached” screen G0 shown in FIG. 9B until the display control in step S17 in FIG. 8 is started.

FIG. 9C is an example of an “attachment is attached” screen G1a. An example of the display control in step S17 in FIG. 8 is a control in which the controller 21 causes the user interface 25 to display the “attachment is attached” screen G1a shown in FIG. 9C and display, on the “attachment is attached” screen G1a, an “attachment is attached” window W1a indicating that the attachment 30 is attached to the quick hitch 16. The “attachment is attached” screen G1a displays an icon Ic1 representing the attached attachment 30 (FIG. 9C shows an icon Ic1 schematically representing a side view of an angle broom). The “attachment is attached” window W1a includes a minimize button B1. When the minimize button B1 is tapped, the controller 21 minimizes the “attachment is attached” window W1a. The controller 21 may minimize the “attachment is attached” window W1a after a predetermined period of time from when the display control in step S17 in FIG. 8 is started. The controller 21, after minimizing the “attachment is attached” window W1a, causes the user interface 25 to display the “attachment is attached” screen G1a as illustrated in FIG. 9D.

FIG. 9E illustrates the “attachment is attached” screen G1a after the control corresponding to the attachment 30 is started on the working vehicle 1. The controller 21, after starting the control of output of hydraulic fluid to the attachment 30b in step S18 in FIG. 8, causing an object “ON” to be displayed in the vicinity of the icon Ic1 on the “attachment is attached” screen G1a as shown in FIG. 9E, which indicates that the control of output of hydraulic fluid is being performed and the attachment 30b can be actuated. The controller 21 may indicate that hydraulic fluid is being outputted to the attachment 30b and the attachment 30b is being actuated by displaying the icon Ic1 representing the attachment 30b in a different manner (in a different color, in a highlighted manner, etc.)

Note that, in the case where the attachment 30 attached to the quick hitch 16 is an attachment 30 including no hydraulic actuators 36 such as a bucket 30a, the controller 21 does not cause the control valve 40d to output hydraulic fluid from the hydraulic fluid outlet port 18a to the attachment 30 based on the control data. The controller 21 may start, for example, control such as adjusting and/or limiting the travel speed and/or speed stage of the working vehicle 1 and/or the height of the raised/lowered booms 11, as the control corresponding to the attachment 30 in step S18.

On the contrary, if the internal memory 21a stores no attachment IDs (NO in S13), the controller 21 determines whether or not the beacon scanner 23 has received any advertisement signals Q1 from beacon transmitter(s) 33 (S19). For example, assume that the beacon scanner 23 receives an advertisement signal Q1 within a reception waiting period Tw (NO in S20) from when the attaching switch 26 has been operated continuously for the second predetermined period Ta or more (S11) (YES in S19). In such a case, the controller 21 identifies the attachment 30 attached to the quick hitch 16 based on the attachment ID included in this advertisement signal Q1 (S21). Next, the controller 21 performs steps S16 to S18 as described earlier.

If the beacon scanner 23 does not receive any advertisement signals Q1 within the reception waiting period Tw (NO in S19, YES in S20), the controller 21 causes the user interface 25 to display an attachment list L1 indicating attachment(s) 30 attachable to the quick hitch 16 (S22). The reception waiting period Tw is, for example, about 10 seconds.

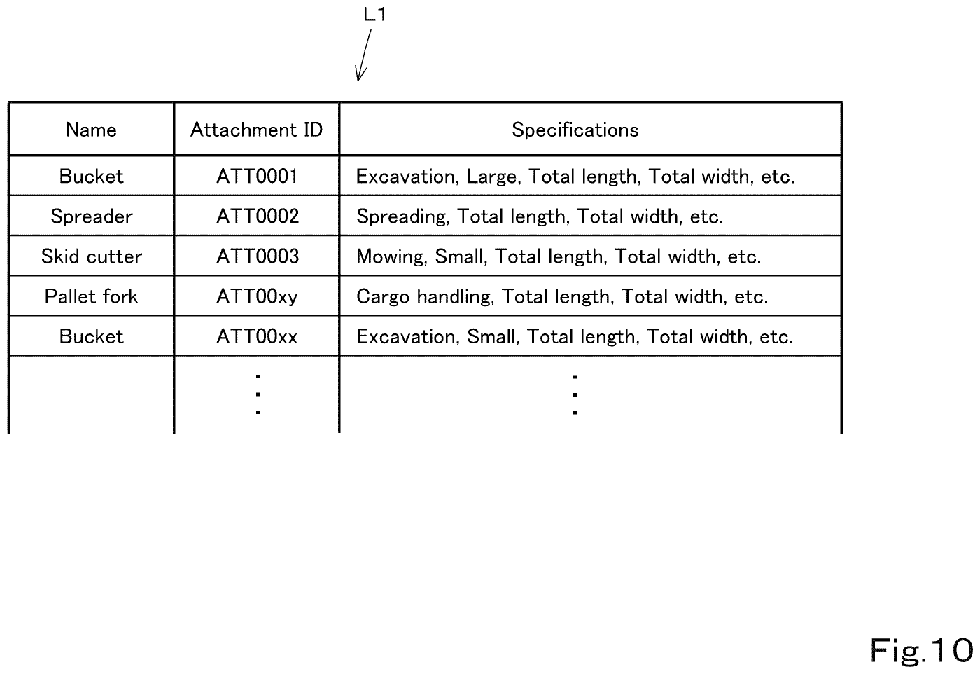

FIG. 10 shows an example of the attachment list L1. The data of the attachment list L1 is stored in the nonvolatile memory 22. The attachment list L1 displayed by the user interface 25 includes, for example, pieces of attachment information such as the names, the attachment IDs, and/or the specifications of the attachments 30 attachable to the quick hitch 16.

The operator selects a piece of attachment information relating to the attachment 30 attached to the quick hitch 16 from the attachment list L1 using the user interface 25 (S23 in FIG. 8). Upon the selection, the controller 21 identifies the attachment 30 attached to the quick hitch 16 based on the selected piece of attachment information (S24). Then, the controller 21 performs steps S16 to S18 as described earlier.

Also in the case where the manual selection mode is selected instead of the automatic selection mode (NO in S12) when the attaching switch 26 has been operated continuously for the second predetermined period Ta or more (S11), the controller 21 causes the user interface 25 to display the attachment list L1 (S22). Next, upon selection of a piece of attachment information by the operator from the attachment list L1 (S23), the controller 21 identifies the attachment 30 attached to the quick hitch 16 based on the selected piece of attachment information (S24). Next, the controller 21 performs steps S16 to S18 as described earlier.

The controller 21 may cause the user interface 25 to display icon(s) (symbol(s)) of the attachment(s) 30 attachable to the quick hitch 16 instead of the attachment list L1 of step S22, for example. In such a case, upon selection (designation) of any of the icons using the user interface 25 by the operator, the controller 21 reads the piece of attachment information of the attachment 30 corresponding to the selected icon from the nonvolatile memory 22, and identifies the attachment 30 attached to the quick hitch 16 based on the piece of attachment information.

Alternatively, the controller 21 may cause the user interface 25 to display an input screen for attachment information such as an attachment ID instead of the attachment list L1 of step S22. In such a case, upon input of a piece of attachment information of the attachment 30 attached to the quick hitch 16 by the operator via the input screen on the user interface 25, the controller 21 identifies the attachment 30 attached to the quick hitch 16 based on the inputted piece of attachment information.

When detaching the attachment 30 from the quick hitch 16, the operator operates the traveling device 5 and/or the working device 4 using the operation member(s) 6 and/or 7 to place the attachment 30 on the ground at a predetermined location. Next, if the operator operates the detaching switch 27 for the first predetermined period Tb or more, the controller 21 causes the latch cylinder 52 to retract. With this, the latch levers 57 pivot upward, the latch pins 54 are withdrawn from the through-holes 71h of the base plate 71 of the attachment 30 as illustrated in FIG. 20A, and the attachment 30 is unlatched from the latching mechanisms 51. That is, the attachment 30 is brought into the attachment detachable state C1 in which the attachment 30 is allowed to be detached from the quick hitch 16 and the working vehicle 1 (FIG. 7). However, if the operation to attach or detach the attachment 30 is repeated within a short period of time, there may be a difference between the state of the attachment 30 and the result of identification of the attachment 30 identified based on a signal from a sensor attached to the attachment 30. To address this, the controller 21 determines whether or not the attachment 30 is in the attachment detachable state C1 based on the difference in time between the operation of the detaching switch 27 and the operation of the attaching switch 26.

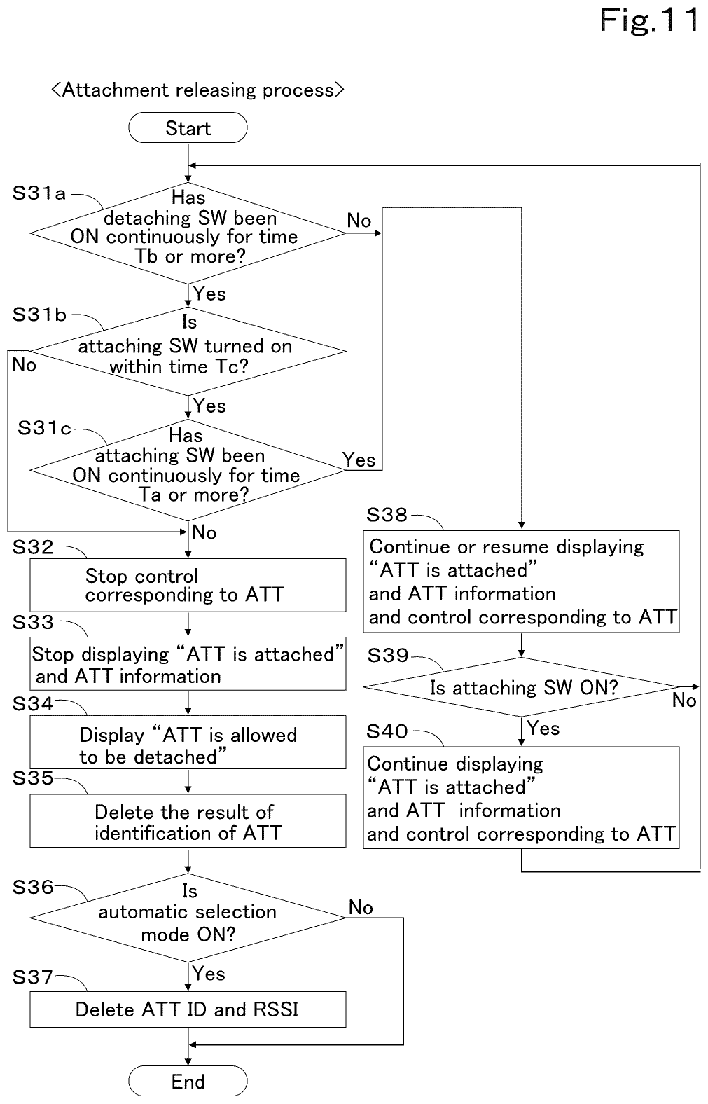

FIG. 11 is a flowchart showing an example of an attachment releasing process. It is noted here that the releasing process is started from the state in which the attachment 30 is attached to the quick hitch 16, i.e., the attachment attached state (C2 in FIG. 7). If the detaching switch 27 is operated and the duration of the operation of the detaching switch 27 is less than the first predetermined period Tb (NO in S31a in FIG. 11, condition 5 in FIG. 7), the latching mechanism 51 stays in the latching state. Therefore, the controller 21 determines that the attachment 30 stays in the attachment attached state C2.

Next, the controller 21 continues to perform a display control to display information indicating that the attachment 30 is attached and attachment information indicating the attachment 30 and a control of elements of the working vehicle 1 that corresponds to the attachment 30 (S38). In other words, the controller 21 continues to perform the control started in step S18 and step S17 in FIG. 8 (the predetermined process for cases where an attachment is attached, or with-attachment predetermined process). Alternatively, if the controller 21 detects the operation of the detaching switch 27 and temporarily stops the display control and the control of the elements and then detects that the duration of the operation of the detaching switch 27 is less than the first predetermined period Tb, the controller 21 resumes the display control and the control of the elements (S38).

Even if the attaching switch 26 is operated in the attachment attached state (C2 in FIG. 7) (YES in S39 in FIG. 11, condition 3 in FIG. 7), the controller 21 determines that the attachment 30 stays in the attachment attached state C2, and continues to perform the display control to display the information indicating that the attachment 30 is attached and the attachment information indicating that attachment and the control of the elements of the working vehicle 1 that corresponds to the attachment 30. That is, the controller 21 continues to perform the predetermined process for cases where an attachment is attached (with-attachment predetermined process) (S40).

When the detaching switch 27 is operated (turned ON) continuously for the first predetermined period Tb or more in the attachment attached state (C2 in FIG. 7), the latching mechanisms 51 switch to the unlatching state. However, there may be cases in which the operator wishes to bring the attachment 30 (which has been switched to the unlatching state in which the attachment is unlatched from the latching mechanisms 51) back into the latching state (attachment attached state C2) again. To address this, the controller 21 evaluates the state of the attachment 30 based on whether or not the attaching switch 26 starts to be operated within a third predetermined period Tc from the end of the operation of the detaching switch 27 and based on the duration of the operation of the attaching switch 26.

Specifically, if the attaching switch 26 starts to be operated within the third predetermined period Tc from the end of the continuous operation (turning ON) of the detaching switch 27 for the first predetermined period Tb or more (YES in S31a of FIG. 11) (YES in S31b) and the duration of the operation of the attaching switch 26 is the second predetermined period Ta or more (YES in S31c, condition 6 in FIG. 7), the controller 21 determines that the attachment 30 stays in the attachment attached state C2, and continues to perform the control corresponding to the attachment 30 (the foregoing display control and the control of the elements of the working vehicle 1) without identifying the attachment 30 again (S38). Alternatively, the controller 21, in response to the continuous operation of the detaching switch 27 for the first predetermined period Tb or more (YES in S31a), temporarily stops the control corresponding to the attachment 30 and then, in response to the continuous operation of the attaching switch 26 for the second predetermined period Ta or more started within the third predetermined period Tc (YES in S31b, YES in S31c), resumes the display control and the control of the elements (S38). The third predetermined period Tc is, for example, about 5 seconds.

On the contrary, if the attaching switch 26 does not start to be operated within the third predetermined period Tc from the end of the continuous operation (turning ON) of the detaching switch 27 for the first predetermined period Tb or more (YES in S31a) (NO in S31b, condition 4 in FIG. 7), the attachment 30 is allowed to be detached from the quick hitch 16. Even if the attaching switch 26 starts to be operated within the third predetermined period Tc (YES in S31b), provided that the duration of the operation of the attaching switch 26 is less than the second predetermined period Ta (NO in S31c), the latching mechanisms 51 are brought back by the elastic force of the coil springs 56 to the unlatching state, and the attachment 30 is still allowed to be detached from the quick hitch 16. In such cases, the controller 21 determines that the mechanism 51 is in the attachment detachable state C1.

Next, the controller 21 stops the control corresponding to the attachment 30 (S32). It is noted here that, if the control of the output of hydraulic fluid to the attachment 30 is currently being performed (the control was started in step S18 in FIG. 8), the controller 21 stops the control of the output. In other words, the controller 21 starts a without-attachment predetermined process which is a process based on the precondition that the working vehicle 1 is provided with no attachments 30. With this, the hydraulic fluid stops from being outputted from the working vehicle 1 to the attachment 30.

As a predetermined process for cases where no attachments are attached, the controller 21 stops the display control about the attachment 30 which had been attached to the quick hitch 16 (the display control which was started in step S17 in FIG. 8) (S33). In other words, the controller 21 starts a without-attachment predetermined process which is a process based on the precondition that the working vehicle 1 is provided with no attachments 30. That is, the controller 21 causes the “attachment is attached” screen G1 shown in FIG. 9A to disappear. Next, the controller 21 causes the user interface 25 to display (output) information indicating that the attachment 30 is now allowed to be detached (S34), as the predetermined process for cases where no attachments are attached (without-attachment predetermined process).

It is noted here that the controller 21 causes the user interface 25 to display, for example, an “attachment is allowed to be detached” screen G2 as illustrated in FIG. 12A. The “attachment is allowed to be detached” screen G2 displays a message indicating that the attachment 30 is allowed to be detached, attachment information relating to the attachment 30 (bucket 30a in the example in FIG. 12A), and an icon of the attachment 30. The controller 21 may cause, for example, the “attachment is allowed to be detached” screen G2 to display a message indicating that the control (such as control of output of hydraulic fluid) corresponding to the attachment 30 has stopped. The controller 21 may cause the “attachment is allowed to be detached” screen G2 to be displayed for a period of time and then disappear.

For another example, the controller 21 may cause the communicator 24 to transmit, to a portable device 70, the display data for the “attachment is allowed to be detached” screen G2 and the attachment information relating to the attachment 30 allowed to be detached. The portable device 70 may receive the display data and the attachment information and cause a display to display the “attachment is allowed to be detached” screen G2.

The controller 21 deletes, from the nonvolatile memory 22, the result of identification of the attachment 30 allowed to be detached (S35 in FIG. 11). Note that, for another example, the controller 21 may cause the nonvolatile memory 22 to store the result of identification of the attachment 30, as a history of use of the attachment 30 on the working vehicle 1. The controller 21 deletes the attachment ID and the RSSI stored in the internal memory 21a (S37) in the case where the automatic selection mode is selected (YES in S36).

The controller 21 may cause the user interface 25 to display a screen as illustrated in FIG. 12B, 12C, or 9B as the display control which is an example of the predetermined process for cases where no attachments are attached (without-attachment predetermined process). FIG. 12B illustrates another example of the “attachment is attached” screen G1a. The “attachment is attached” screen G1a in FIG. 12B displays an icon Ic1 representing the attachment 30 attached with the quick hitch 16 (FIG. 12B shows an icon Ic2 schematically representing an elevational view of a rake).

The controller 21 causes the “attachment is attached” screen G1a to disappear (turns OFF) in step S33 in FIG. 11, and then causes the user interface 25 to display an “attachment is not yet attached” screen G0 as illustrated in FIG. 12C, which is step S34. The “attachment is not yet attached” screen G0 is an example of a screen indicating that no attachments 30 are attached.

The controller 21 causes the user interface 25 to display an “attachment is detached” window W2a indicating that the attachment 30 is allowed to be detached. The “attachment is detached” window W2a includes a minimize button B2. When the minimize button B2 is tapped, the controller 21 minimizes the “attachment is detached” window W2a. The controller 21 may minimize the “attachment is detached” window W2a after a predetermined period of time from when the predetermined process for cases where no attachments are attached (without-attachment predetermined process) is started in step S33 in FIG. 11.

The controller 21, after minimizing the “attachment is detached” window W2a, causes the user interface 25 to display the “attachment is not yet attached” screen G0 as illustrated in FIG. 9B. The controller 21 may cause the user interface 25 to continue displaying the “attachment is not yet attached” screen G0 until the controller 21 determines that the latching mechanisms 51 have been switched from the unlatching state to the latching state and the attachment is in the attachment attached state C2. The “attachment is not yet attached” screen G0 displays an object “OFF” indicating that the control of output of hydraulic fluid to the attachment 30 is stopped and no attachments 30 are attached.

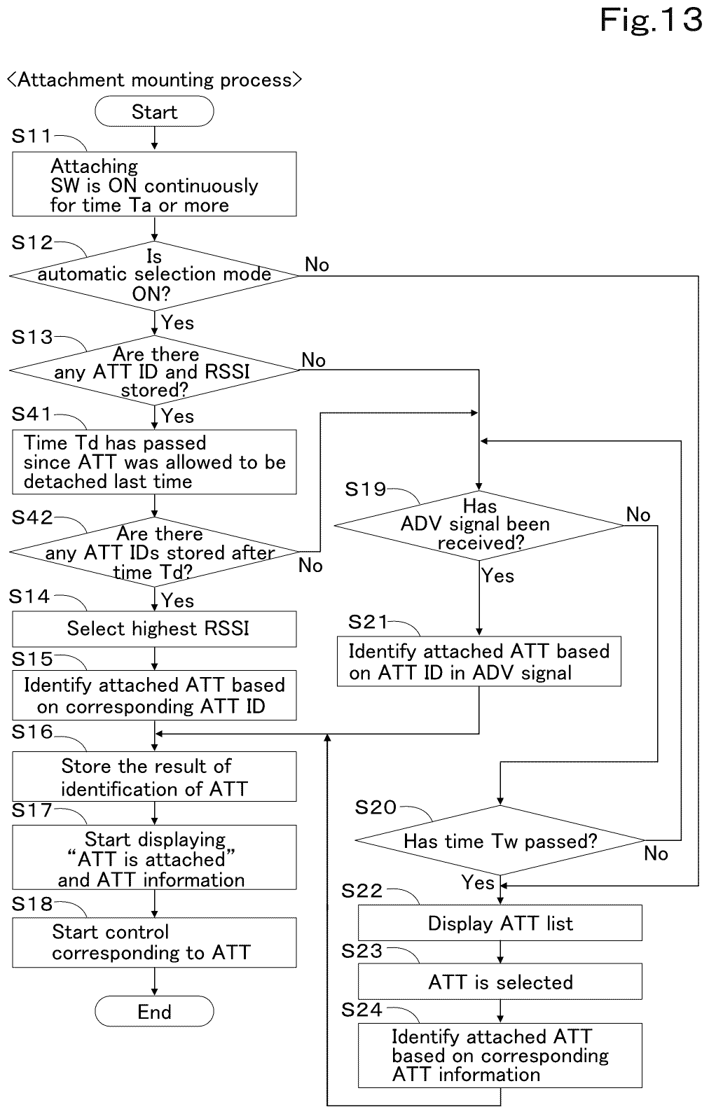

There may be cases in which, immediately after the attachment 30 is detached from the quick hitch 16, another attachment 30 is attached to the quick hitch 16. In such cases, the attachment ID of the detached attachment 30 and the attachment ID of the attached attachment 30 may be stored in the internal memory 21a and the attached attachment 30 may be identified in a wrong manner based on the attachment ID of the detached attachment 30. To address such errors, for example, an attachment mounting process as shown in FIG. 13 may be performed.

FIG. 13 is a flowchart showing another example of the attachment mounting process. As discussed earlier, in the case where the attaching switch 26 is operated for the second predetermined period Ta or longer (S11), the attachment 30 is attached to the quick hitch 16, and the automatic selection mode is selected (S12: YES), the controller 21 determines whether or not the internal memory 21a stores any attachment ID (S13). If the internal memory 21a stores attachment ID(s) (YES in S13), the controller 21 determines whether a fourth predetermined period Td has passed since the controller 21 last determined that the attachment 30 was allowed to be detached upon continuous operation of the detaching switch 27 for the first predetermined period Tb or more (S41). The fourth predetermined period Td is set in consideration of the average time taken to detach an attachment 30 from the quick hitch 16 of the working vehicle 1 and attaching another attachment 30 to the quick hitch 16. Note that the controller 21 may determine whether the fourth predetermined period Td has passed since the end of the previous operation of the detaching switch 27 (since the point in time at which the operator stopped operating the detaching switch 27).

Next, the controller 21 refers to information indicating the time(s) (time stamp(s)) of the attachment ID(s) stored in the internal memory 21a, and determines whether or not any of the attachment ID(s) was stored in the internal memory 21a after the fourth predetermined period Td after the controller 21 determined that the attachment 30 was allowed to be detached. If the internal memory 21a stores attachment ID(s) that was stored after the fourth predetermined period Td (YES in S42), the controller 21 reads the attachment ID(s) (YES in S42), selects the attachment ID with the highest RSSI from the attachment ID(s) (S14), and identifies the attachment 30 attached to the quick hitch 16 (S15).

On the contrary, if there are no attachment IDs that were stored in the internal memory 21a after the fourth predetermined period Td (NO in S42), the controller 21 performs steps S19 to S21 as discussed earlier, and identifies the attached attachment 30 based on the attachment ID included in the advertisement signal Q1 received by the beacon scanner 23 within the reception waiting period Tw. If the beacon scanner 23 receives no advertisement signals Q1 within the reception waiting period Tw, the controller 21 performs steps S22 to S24 and identifies the attachment 30. Then, the controller 21 performs steps S16 to S18 as discussed earlier.

Since the controller 21 performs the attachment mounting process in FIG. 13 in such a manner, even if, after the attachment 30 is allowed to be detached from the quick hitch 16, the attachment ID of the attachment 30 is stored in the internal memory 21a within the fourth predetermined period Td, the controller 21 does not use the attachment ID to identify another attachment 30 attached to the quick hitch 16 next.

The hydraulic fluid used to actuate the latching mechanisms 51 changes in fluidity with temperature, and therefore the time taken for the latching mechanisms 51 to switch from the unlatching state to the latching state or switch from the latching state to the unlatching state changes. In consideration of such characteristics, the controller 21 may change the first predetermined period Tb used to determine that the attachment 30 is allowed to be detached (value for use in evaluation of the duration of operation of the detaching switch 27) and/or the second predetermined period Ta used to determine that the attachment 30 is attached (value for use in evaluation of the duration of operation of the attaching switch 26) depending on at least one of air temperature or the temperature of the hydraulic fluid. The air temperature and the temperature of the hydraulic fluid may be detected by temperature sensor(s) in or on the working vehicle 1 and may be manually inputted via the user interface 25.

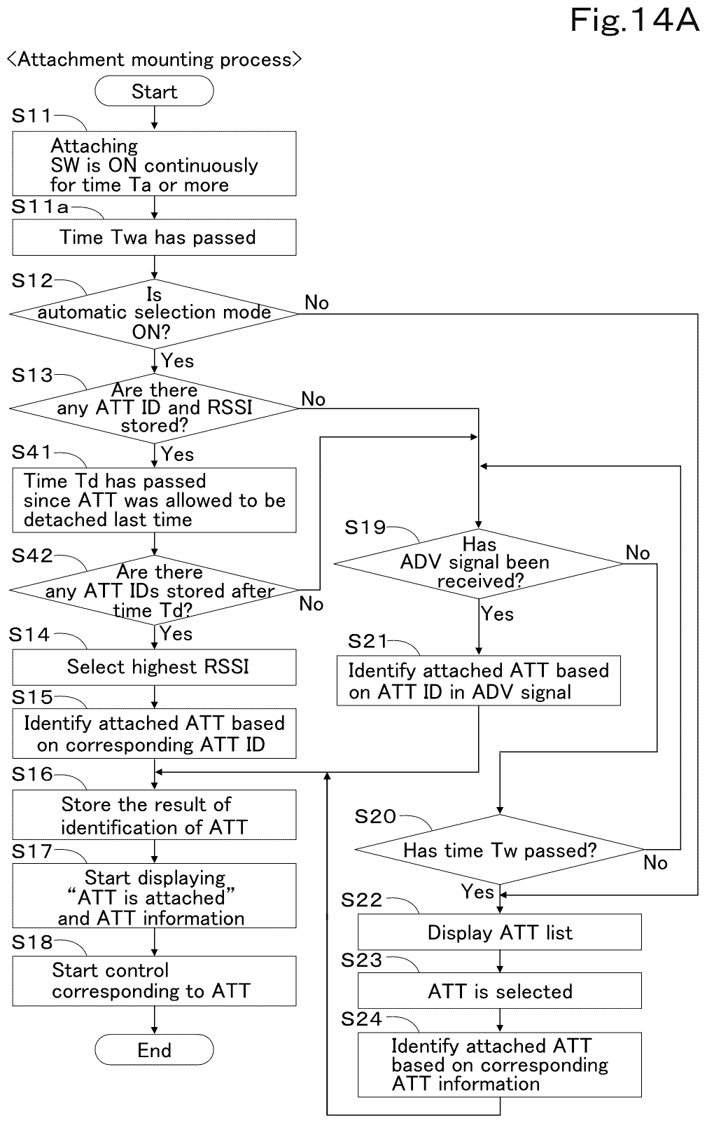

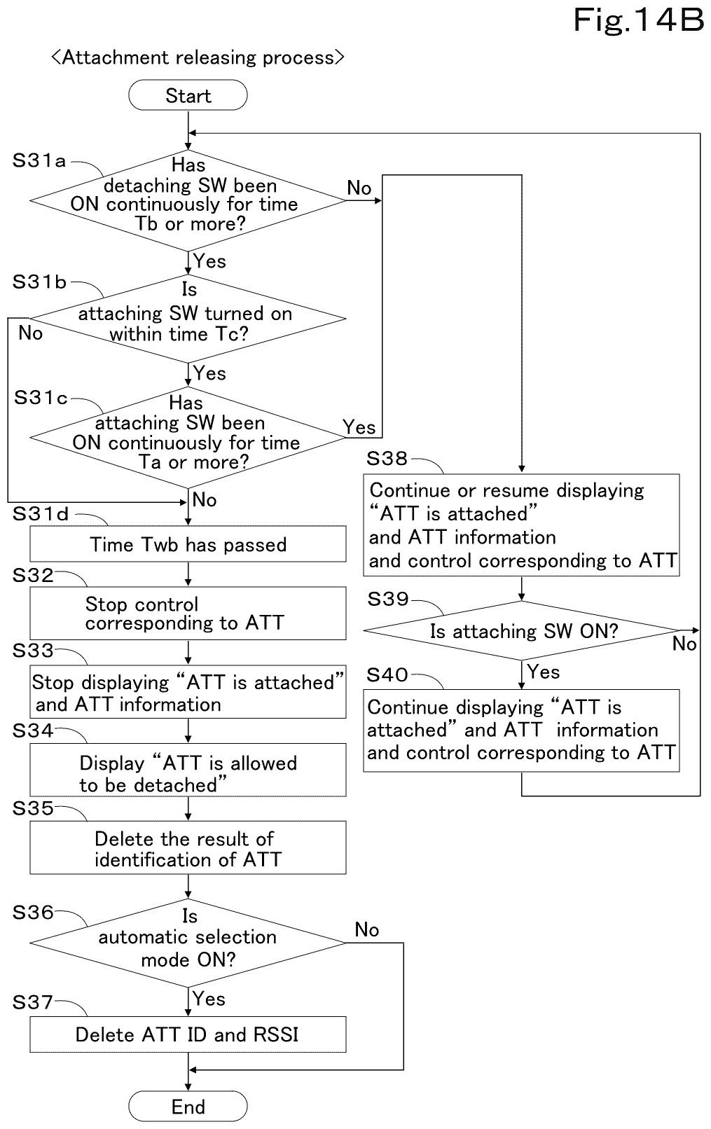

A second actuation period Twa taken for the latching mechanisms 51 to be actuated from the unlatching state to the latching state and a first actuation period Twb taken for the latching mechanisms 51 to be actuated from the latching state to the unlatching state may be set and stored in, for example, the nonvolatile memory 22. In such a case, the controller 21 may determine that the attachment 30 is attached when the attaching switch 26 is operated continuously for the second predetermined period Ta or more and the second actuation period Twa has passed since the start of the operation of the attaching switch 26, as shown in, for example, FIG. 14A. The controller 21 may determine that the attachment 30 is allowed to be detached when the detaching switch 27 is operated continuously for the first predetermined period Tb or more and the first actuation period Twb has passed since the start of the operation of the detaching switch 27, as shown in, for example, FIG. 14B.

FIG. 14 is a flowchart showing another example of the attachment mounting process. When the attaching switch 26 is operated (turned ON) continuously for the second predetermined period Ta or more as discussed earlier (S11), the controller 21 waits until the second actuation period Twa has passed since the start of the operation of the attaching switch 26. Upon the elapse of the second actuation period Twa (S11a), the quick hitch 16 is brought into the latching state, and therefore the controller 21 determines that the attachment attached state C2 is entered. After that, as discussed earlier, if the automatic selection mode is selected (YES in S12), the controller 21 refers to the internal memory 21a and identifies the attachment (S13, S41, S42, S14 to S15, and S19 to S21).

In contrast, if the automatic selection mode is not selected (NO in S12), the controller 21 causes the attachment list L1 to be displayed and identifies the attachment based on the selection by the operator (S22 to S24). Next, the controller 21 causes the nonvolatile memory 22 to store the result of identification of the attachment 30 (S16), starts the display control to cause the user interface 25 to display (output) the information indicating that the attachment 30 is attached and the attachment information indicating the attached attachment 30 (S17), and starts a control process corresponding to the attachment information (S18).

FIG. 14B is a flowchart showing another example of the attachment releasing process. If the detaching switch 27 is operated (turned ON) continuously for the first predetermined period Tb or more (YES in S31a) and thereafter the attaching switch 26 is not operated during the third predetermined period Tc (NO in S31b), the controller 21 waits until the first actuation period Twb has passed since the start of the operation of the detaching switch 27 (S31d). Also if the detaching switch 27 if operated (turned ON) continuously for the first predetermined period Tb or more (YES in S31a) and the attaching switch 26 is operated before the end of the third predetermined period Tc (YES in S31b) but the duration of the operation of the attaching switch 26 is less than the second predetermined period Ta (NO in S31c), the controller 21 waits until the first actuation period Twb has passed since the start of the operation of the detaching switch 27 (S31d). Upon the elapse of the first actuation period Twb (S31d), the quick hitch 16 switches to the unlatching state. The controller 21 therefore determines that the attachment detachable state C1 is entered and performs steps S32 to S37 which are the predetermined process for cases where no attachments are attached (without-attachment predetermined process).

If, for example, a stop switch in or on the working vehicle 1 is operated or an engine stall occurs with the attachment 30 attached to the quick hitch 16, the prime mover 9 stops and the working vehicle 1 also stops. After that, when a starting switch in or on the working vehicle 1 is operated and thus the prime mover 9 is restarted, the control that corresponds to the attachment 30 attached to the quick hitch 16 is preferably started quickly.

If the prime mover 9 of the working vehicle 1 stops temporarily and then is restarted with the attachment 30 attached to the quick hitch 16, the controller 21 does not perform the process to identify the attachment 30 and continues to perform the predetermined process for cases where an attachment is attached (with-attachment predetermined process) based on the attachment information of the attachment 30 identified before the prime mover 9 stopped. If the attachment 30 attached to the quick hitch 16 includes a hydraulic actuator 36, the controller 21 causes the “attachment is attached” screen G1 to display such and waits until the auxiliary mode switch 28 is operated.

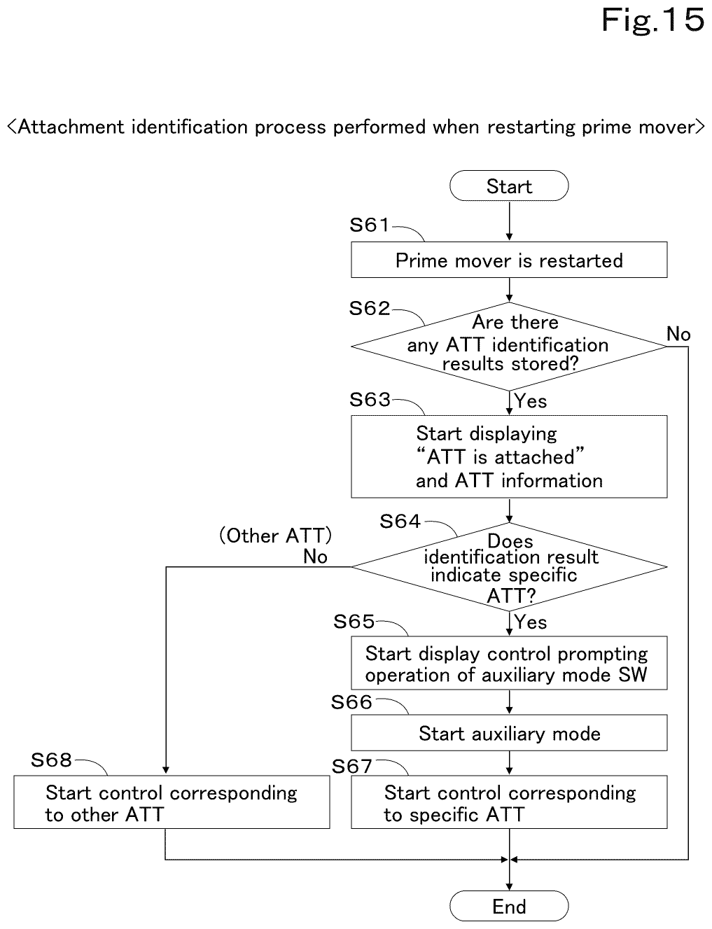

FIG. 15 is a flowchart showing an example of an attachment identification process performed when the prime mover 9 is restarted. If the prime mover 9 temporarily stops and then is restarted (S61), the controller 21 refers to information stored in the nonvolatile memory 22. If the nonvolatile memory 22 stores the result of identification of the attachment 30 (YES in S62), the controller 21 determines that the attachment 30 indicated by the result of identification is attached (identification of the attachment 30), and starts performing a display control to cause the user interface 25 to display (output) information indicating that the attachment 30 is attached and attachment information indicating the attached attachment 30, i.e., the predetermined process for cases where an attachment is attached (with-attachment predetermined process) (S63).

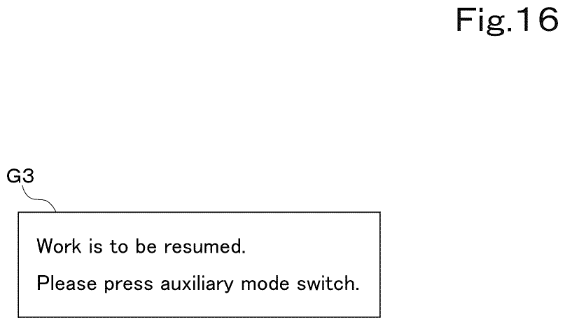

If the result of identification of the attachment 30 indicates a specific attachment, i.e., an attachment 30 including a hydraulic actuator 36 (YES in S64), the controller 21 starts performing a display control to cause the user interface 25 to output a prompt asking for operation of the auxiliary mode switch 28 to start actuating the hydraulic actuator 36 (S65). In so doing, for example, the controller 21 causes the user interface 25 to output a pop-up window G3 as illustrated in FIG. 16 on the “attachment is attached” screen G1. The pop-up window G3 includes information (message) indicating that work will be resumed and asking for operation of the auxiliary mode switch 28.

After that, if the auxiliary mode switch 28 is operated and the auxiliary mode is started (S66), the controller 21 reads, from the nonvolatile memory 22, a piece of control data that corresponds to the attachment 30 indicated by the result of identification, and starts a control that corresponds to the attachment 30 based on the piece of control data (S67). That is, the controller 21 starts the predetermined process for cases where an attachment is attached (with-attachment predetermined process) that corresponds to the attachment 30. The attachment 30 attached to the quick hitch 16 here is an attachment 30 including a hydraulic actuator 36, and therefore the controller 21 causes the control valve 40d to allow hydraulic fluid to flow through the hydraulic fluid outlet port 18a to the attachment 30 based on the piece of control data. The controller 21 also control output of hydraulic fluid to the attachment 30 in response to operation of the auxiliary output switch 29 by the operator.

On the contrary, if the result of identification of the attachment 30 indicates another attachment including no hydraulic actuators 36 (NO in S64), the controller 21 starts a control that corresponds to the other attachment 30 as the process for cases where an attachment is attached (S68).

A first set period Tb1 which is equal to or longer than the first predetermined period Tb (value for use in evaluation of the duration of operation of the detaching switch 27) and a second set period Ta2 which is equal to or longer than the second predetermined period Ta (value for use in evaluation of the duration of operation of the attaching switch 26) may be stored in the nonvolatile memory 22 and/or the internal memory 21a. In such a case, the first set period Tb1 and the second set period Ta2 may be the same or different. In the present preferred embodiment, the first set period Tb1 is about 2.0 seconds, and the second set period Ta2 is about 1.8 seconds.

The controller 21, when the detaching switch 27 is operated continuously for the first set period Tb1 or more, determines that the attachment 30 is allowed to be detached from the quick hitch 16 (the unlatching state is entered), and starts a without-attachment predetermined process. The controller 21, when the attaching switch 26 is operated continuously for the second set period Ta2 or more, determines that the attachment 30 is attached to the quick hitch 16 (latching state is entered) and starts a with-attachment predetermined process.

In the above-described preferred embodiments, an example case in which hydraulic actuators (such as the boom cylinders 14, the front cylinders 15, the latch cylinder 52) are provided in the working device 4, the quick hitch 16, and a specific attachment 30b is discussed. Additionally or alternatively, electric actuator(s) may be provided in the working device 4, the quick hitch 16, and/or the specific attachment 30b. For example, in the case where an attachment including an electric actuator is attached to the quick hitch 16, the controller 21 need only output, to the attachment 30 through external electric wire(s), electricity (power) from the battery 20 (FIG. 1) as power for the electric actuator based on the control data corresponding to the attachment.

The time taken for the latching mechanisms 51 to switch from the unlatching state to the latching state and the time taken for the latching mechanisms 51 to switch from the latching state to the unlatching state vary depending on the quick hitch 16 and the configuration (hydraulic or electric) of the latch actuator (latch cylinder) 52. Therefore, the first set period Tb1 and the second set period Ta2 may be changed depending on the quick hitch 16 and the configuration of the latch actuator 52. The time taken for the latching mechanisms 51 to switch from the unlatching state to the latching state and the time taken for the latching mechanisms 51 to switch from the latching state to the unlatching state vary also depending on the state of the working vehicle 1. Therefore, the first set period Tb1 and the second set period Ta2 may be changed depending on the state of the working vehicle 1.

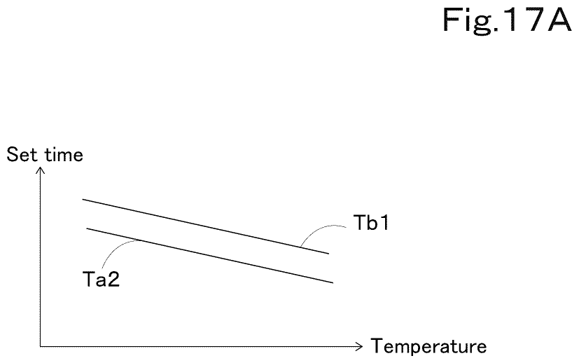

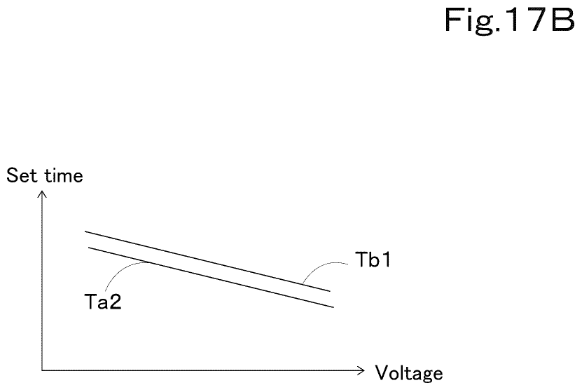

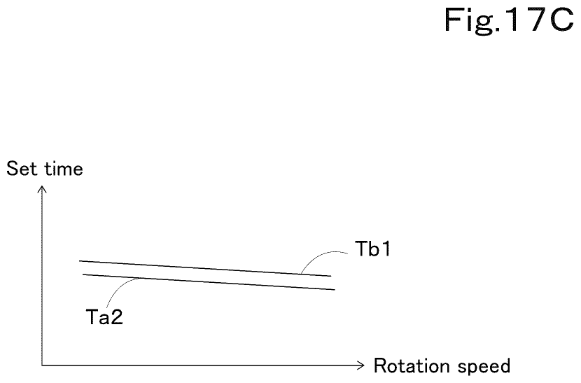

For example, in the case where the latch actuator 52 is a hydraulic cylinder, since hydraulic fluid changes in fluidity with temperature, the time taken for the latching mechanisms 51 to switch between the latching state and the unlatching state increases as the temperature of hydraulic fluid decreases. To address this, the controller 21 may increase the first set period Tb1 and the second set period Ta2 as the air temperature or the temperature of hydraulic fluid detected by a temperature sensor decreases, according to, for example, the control map shown in FIG. 17A. FIG. 17A shows an example in which the first set period Tb1 is longer than the second set period Ta2, but the first set period Tb1 may be shorter than the second set period Ta2 or may be the same as the second set period Ta2 (the same applies to the examples shown in FIGS. 17B and 17C (described later)).

In the case where the latch actuator 52 is an electric motor, the rotation speed of the electric motor decreases as the voltage acting on the electric motor decreases, resulting in an increase in the time taken for the latching mechanisms 51 to switch between the latching state and the unlatching state. To address this, the controller 21 may increase the first set period Tb1 and the second set period Ta2 as the voltage acting on the electric motor decreases, according to, for example, the control map shown in FIG. 17B.

In the case where the working vehicle 1 includes a hydraulic circuit to drive a rotary hydraulic device (hydraulic fan to cool the engine) as illustrated in, for example, FIG. 4 of U.S. Patent Application Publication No. 2016/0305093, the hydraulic pressure in a fluid passage upstream of a hydraulic motor which supplies hydraulic fluid to drive the hydraulic device to rotate increases as the set rotation speed of the hydraulic device increases, resulting in a reduction in the time taken for the latch cylinder 52 to switch the latching mechanisms 51 between the latching state and the unlatching state. To address this, the controller 21 may reduce the first set period Tb1 and the second set period Ta2 as the set rotation speed of the hydraulic device increases, according to, for example, the control map shown in FIG. 17C.

Also in the case where the working vehicle 1 includes a hydraulic circuit to drive a hydraulic device other than the above rotary hydraulic device, the controller 21 may similarly reduce the first set period Tb1 and the second set period Ta2 as the hydraulic pressure in the fluid passage upstream of the hydraulic device increases (or as the amount of hydraulic fluid flowing through the fluid passage increases). As illustrated in FIG. 1, the working vehicle 1 according to the present preferred embodiment includes a rotary hydraulic device 72 such as a hydraulic fan, another hydraulic device 73 other than the rotary hydraulic device, and a hydraulic circuit 71 to drive the rotary hydraulic device 72 and the other hydraulic device 73. The hydraulic circuit 71 is supplied with hydraulic fluid from the main pump P1.

The controller 21 may set the first set period Tb1 and the second set period Ta2 according to the value(s) of at least one of the following parameters (control values): the foregoing temperature, temperature of hydraulic fluid, hydraulic pressure, voltage, and rotation speed. The values of the parameters may be manually inputted via the user interface 25 instead of or in addition to being detected by a sensor in or on the working vehicle 1.

In the above-described preferred embodiments, each attachment 30 is provided with a beacon transmitter 33 to transmit a wireless signal (advertisement signal Q1) compliant with Bluetooth (registered trademark) Low Energy, and the working vehicle 1 is provided with a beacon scanner 23 to receive the wireless signals. However, additionally or alternatively, for example, the attachment 30 may be provided with a transmitter such as a radio frequency identification (RFID) tag, and the working vehicle 1 may be provided with a receiver to receive wireless signals transmitted from the RFID. Additionally or alternatively, the attachment 30 may be provided with a transmitter to transmit radio waves for some other near field communication, and the working vehicle 1 may be provided with a receiver to receive the radio waves.

In the above-described preferred embodiments, the working vehicle 1 is provided with the quick hitch 16. Alternatively, the working vehicle 1 may be provided with a hitch having a different structure from the quick hitch 16, a quick hitch to which an attachment 30 can be attached and detached both automatically and manually, or a hitch to which an attachment 30 can be attached and detached only manually. In the case where the operator manually attaches the attachment 30 to the hitch or manually detaches the attachment 30 from the hitch, the operator may input information indicating that the attachment 30 is attached or detached using the user interface 25.

In the above-described preferred embodiments, the operator inputs attachment information relating to the attachment 30 attached to the quick hitch 16 using the user interface 25 provided in or on the working vehicle 1. However, for example, the operator may input attachment information relating to the attachment 30 attached to the quick hitch 16 using a portable device 70. That is, the portable device 70 may be used as a user interface instead of the user interface 25.

In such a case, upon input of attachment information into the portable device 70, the portable device 70 transmits the attachment information to the communicator 24 of the working vehicle 1 via the Internet and/or the like. Upon receipt of the attachment information by the communicator 24, the controller 21 of the working vehicle 1 identifies the attachment 30 attached to the quick hitch 16 based on the attachment ID included in the attachment information.

An attachment including a work member to be actuated by power from the prime mover 9 of the working vehicle 1 may be attached to the quick hitch 16. In the case where such an attachment including a work member is attached to the quick hitch 16, the controller 21 may output power from the prime mover 9 to the attachment 30 via a power transmission mechanism including gear(s), shaft(s), and/or the like based on control data corresponding to the attachment.

A working vehicle 1 and an attachment usage system 100 according to one or more preferred embodiments each include a hitch (quick hitch) 16 to attach and detach an attachment 30 thereto and therefrom, at least one operation switch (attaching switch 26, detaching switch 27) to be operated to attach or detach the attachment 30 to or from the hitch 16, a receiver (beacon scanner) 23 to receive a wireless signal (advertisement signal Q1) which is transmitted periodically from a transmitter (beacon transmitter) 33 in or on the attachment 30, which includes identification information (attachment ID) of the attachment 30, and which is compliant with a near field communication standard, and a controller 21 to perform a predetermined process based on the identification information included in the wireless signal received by the receiver 23, wherein the hitch 16 includes a latching mechanism 51 operable selectively in a latching state in which the attachment 30 is secured to the hitch 16 and an unlatching state in which the attachment 30 is not secured to the hitch 16, and a latch actuator (latch cylinder) 52 to actuate the latching mechanism 51 between the latching state and the unlatching state while the at least one operation switch is being operated, and the controller 21 is configured or programmed to, when the at least one operation switch is operated continuously for a first predetermined period Tb or more or for a second predetermined period Ta or more, determine that the attachment 30 is allowed to be detached from the hitch 16 or is attached to the hitch 16 and start the predetermined process, the first predetermined period being a period of time taken for the latching mechanism 51 to switch from the latching state to the unlatching state, the second predetermined period being a period of time taken for the latching mechanism 51 to switch from the unlatching state to the latching state.

With the above configuration, the controller 21 determines that the attachment 30 is allowed to be detached from the hitch 16 or is attached to the hitch 16 when the attachment 30 is actually unlatched from or latched by the latching mechanism 51, and therefore it is possible to eliminate or reduce the likelihood that the actual state of the attachment 30 (actually attached to the working vehicle 1 or actually allowed to be detached from the working vehicle 1) will differ from the attached state or the detachable state electrically detected by the controller 21. Furthermore, the controller 21 can identify the attachment 30 actually attached to the hitch 16. The controller 21 can then perform a process corresponding to the attachment 30 actually attached to the hitch 16. That is, it is possible to reliably link and match the latching state or the unlatching state of the latching mechanism 51 with a process to be performed when the working vehicle 1 is provided with the attachment 30 or a process to be performed when the working vehicle 1 is provided with no attachments 30.

In one or more preferred embodiments, the at least one operation switch may include a detaching switch 27 to be operated to allow the attachment 30 to be detached from the hitch 16. The controller 21 may be configured or programmed to, when the detaching switch 27 is operated continuously for the first predetermined period Tb or more, determine that the attachment 30 is allowed to be detached from the hitch 16 and start a without-attachment predetermined process as the predetermined process, the without-attachment predetermined process being a process based on a precondition that the working vehicle 1 is provided with no attachments 30. With this, since the controller 21 starts the without-attachment predetermined process after the latching mechanism 51 has switched from the latching state to the unlatching state, it is possible to reliably link and match the state of the attachment 30 (in which the attachment 30 is allowed to be detached from the hitch 16) with the status of the without-attachment predetermined process.

In one or more preferred embodiments, the at least one operation switch may include an attaching switch 26 to be operated to attach the attachment 30 to the hitch 16. The controller 21 may be configured or programmed to, when the attaching switch 26 is operated continuously for the second predetermined period Ta or more, determine that the attachment 30 indicated by the identification information included in the wireless signal received by the receiver 23 is attached to the hitch 16 and start a with-attachment predetermined process as the predetermined process, the with-attachment predetermined process being a process based on a precondition that the working vehicle 1 is provided with the attachment. With this, the controller 21 identifies the attachment 30 and starts the with-attachment predetermined process after the latching mechanism 51 has been switched from the unlatching state to the latching state. It is therefore possible to accurately identify the attachment 30 attached to the hitch 16, and also possible to reliably link and match the state of the attachment 30 (in which the attachment 30 is attached to the hitch 16) with the status of the with-attachment predetermined process. If the attaching switch 26 is not operated continuously for the second predetermined period Ta or more, the controller 21 does not identify the attachment 30. This makes it possible to eliminate or reduce the likelihood that the controller 21 will wrongly identify the attachment 30 actually not attached to the hitch 16 as the attached attachment, and also possible to reduce the processing load on the controller 21.

In one or more preferred embodiments, the controller 21 may be configured or programmed to, when the attachment 30 is attached to the hitch 16 and the controller 21 is performing the with-attachment predetermined process, if the detaching switch 27 is operated and a duration of operation of the detaching switch 27 is less than the first predetermined period Tb (condition 5), continue to perform the with-attachment predetermined process or stop the with-attachment predetermined process temporarily and then resume the with-attachment predetermined process.

If the duration of continuous operation of the detaching switch 27 is less than the first predetermined period Tb, the latching mechanism 51 does not enter the unlatching state but returns to the latching state, and the controller 21 continues the with-attachment predetermined process corresponding to the attachment 30 or temporarily stops and then resumes the with-attachment predetermined process. It is therefore possible to more reliably link and match the state of the attachment 30 (in which the attachment 30 is attached) with the status of the with-attachment predetermined process. It is also possible to eliminate or reduce the likelihood that the with-attachment predetermined process will be interrupted or stopped when the operator accidentally operates the detaching switch 27. Furthermore, the operator can know that the attachment 30 is in the attached state and the control corresponding to the attachment 30 is being performed, without having to closely look at whether the latching mechanism 51 is latching the attachment 30 or unlatching the attachment 30.

In one or more preferred embodiments, the controller 21 may be configured or programmed to, when the attachment 30 is attached to the hitch 16 and the controller 21 is performing the with-attachment predetermined process, if the attaching switch 26 is operated (condition 3), continue to perform the with-attachment predetermined process. That is, provided that the attachment 30 is secured to the hitch 16, the controller 21 does not identify the attachment 30 even if the operator operates the attaching switch 26. With this, even if the receiver 23 receives a wireless signal from another attachment when the attaching switch 26 is operated with the attachment 30 attached to the hitch 16, the controller 21 continues the with-attachment predetermined process corresponding to the attached attachment 30. This makes it possible to reduce the processing load on the controller 21 and eliminate or reduce the likelihood that the controller 21 will wrongly identify the attachment 30. It is also possible to prevent or reduce the complexity of the process of identifying the attachment 30 by the controller 21.

In one or more preferred embodiments, the controller 21 may be configured or programmed to, when the attachment 30 is attached to the hitch 16 and the controller 21 is performing the with-attachment predetermined process, if the detaching switch 27 is operated continuously for the first predetermined period Tb or more and then the attaching switch 26 instead of the detaching switch 27 starts to be operated within a third predetermined period Tc and is operated continuously for the second predetermined period Ta or more (condition 6), continue to perform the with-attachment predetermined process or stop the with-attachment predetermined process temporarily and then resume the with-attachment predetermined process.

That is, when the attachment 30 is in the attached state, if the detaching switch 27 is operated continuously for the first predetermined period Tb or more and then the attaching switch 26 starts to be operated within the third predetermined period Tc and is operated continuously for the second predetermined period Ta or more, the controller 21 determines that the attachment attached state C2 is continuing and continues to perform the with-attachment predetermined process performed until when the detaching switch 27 is operated, without identifying the attachment 30 again. With this, even if the operator operates the detaching switch 27 to allow the attachment 30 to be detached from the hitch 16 and then immediately operates the attaching switch 26 to attach the same attachment 30 to the hitch 16 in order to use the same attachment 30, the attachment 30 is not identified again. This makes it possible to easily reduce the processing load on the controller 21 and also possible to link and match the state of the attachment 30 (in which the attachment 30 is attached) with the status of the with-attachment predetermined process.

In one or more preferred embodiments, the controller 21 may be configured or programmed to, if the attaching switch 26 is operated continuously for the second predetermined period Ta or more after the controller 21 has determined that the attachment 30 is allowed to be detached, read identification information included in a wireless signal received by the receiver 23 after a fourth predetermined period Td after the controller 21 has determined that the attachment 30 is allowed to be detached and determine that an attachment 30 indicated by the identification information is attached to the hitch 16. With this, it is possible to eliminate or reduce the likelihood that the identification information included in a wireless signal received by the receiver 23 within the fourth predetermined period Td after the continuous operation of the attaching switch 26 for the second predetermined period Ta or more, i.e., the identification information of the attachment 30 which is allowed to be detached from the hitch 16, will be used to identify an attachment 30 attached to the hitch 16 next. It follows that it is possible to eliminate or reduce the likelihood that, in the case where the attachment 30 detached from the hitch 16 differs from the attachment 30 attached to the hitch 16 next, the controller 21 will wrongly identify the detached attachment 30 as the attached attachment 30, and possible to accurately identify the actually attached attachment 30.

In one or more preferred embodiments, the working vehicle 1 may include a user interface 25 to output information indicating that the attachment 30 is allowed to be detached. The controller 21 may be configured or programmed to perform, as the without-attachment predetermined process, a process to cause the user interface 25 to output information indicating that the attachment 30 is allowed to be detached. This allows the operator of the working vehicle 1 to know that the attachment 30 is allowed to be detached from the hitch 16.

In one or more preferred embodiments, the working vehicle 1 may include a user interface 25 to output information indicating that the attachment 30 is attached. The controller 21 may be configured or programmed to perform, as the with-attachment predetermined process, a process to cause the user interface 25 to output information indicating that the attachment 30 is attached. This allows the operator of the working vehicle 1 to know that the attachment 30 is attached to the hitch 16 and the working vehicle 1 and what attachment 30 is attached.

In one or more preferred embodiments, the working vehicle 1 may further include a first memory (nonvolatile memory) 22 to store one or more pieces of control data set for respective one or more of the attachments 30. The controller 21 may be configured or programmed to start, as the with-attachment predetermined process, a process including reading, from the first memory 22, one of the one or more pieces of control data that corresponds to one of the one or more attachments 30 that is attached to the hitch 16 and controlling output of power to the one of the one or more attachments 30 based on the read one of the one or more pieces of control data. With this, the operator can start the work that corresponds to the attachment 30 appropriately immediately after attaching the attachment 30 to the hitch 16.

In one or more preferred embodiments, the controller 21 may be configured or programmed to, when the detaching switch 27 is operated continuously for the first predetermined period Tb or more and a first actuation period Twb has passed since a start of operation of the detaching switch 27, determine that the attachment 30 is allowed to be detached from the hitch 16 and start a without-attachment predetermined process as the predetermined process, the without-attachment predetermined process being a process based on a precondition that the working vehicle is provided with no attachments. The controller 21 may be configured or programmed to, when the attaching switch 26 is operated continuously for the second predetermined period Ta or more and a second actuation period Twa has passed since a start of operation of the attaching switch 26, determine that the attachment 30 is attached to the hitch 16 and start a with-attachment predetermined process as the predetermined process, the with-attachment predetermined process being a process based on a precondition that the working vehicle 1 is provided with the attachment 30. With this, the controller 21 can reliably link and match the without-attachment predetermined process and the with-attachment predetermined process regarding the attachment 30 on the working vehicle 1 with the actual unlatching state and latching state of the latching mechanism 51, making it possible to eliminate or reduce the likelihood that a different will occur between them.

In one or more preferred embodiments, the working vehicle 1 may further include a prime mover 9, and a second memory (nonvolatile memory 22 or internal memory 21a). The controller 21 may be configured or programmed to, upon determining that the attachment 30 is attached to the hitch 16, identify the attachment 30 based on the identification information included in the wireless signal transmitted from the transmitter 33 in or on the attachment 30 and received by the receiver 23 and cause the second memory to store a result of identification of the attachment 30, and if the prime mover 9 is temporarily stopped and then is restarted with the attachment 30 attached to the hitch 16, start the with-attachment predetermined process corresponding to the result of identification of the attachment 30 stored in the second memory. With this, in the case where the prime mover 9 is restarted with the attachment 30 attached to the hitch 16, the process to identify the attachment 30 is not performed. This makes it possible to appropriately and immediately start the work corresponding to the attachment 30 and the with-attachment predetermined process.

In one or more preferred embodiments, the controller 21 may be configured or programmed to, if the prime mover 9 is temporarily stopped and then is restarted with the attachment 30 attached to the hitch 16, cause a user interface 25 to output the result of identification of the attachment 30 stored in the second memory. With this, the operator of the working vehicle 1 can, when the prime mover 9 is restarted with the attachment 30 attached to the hitch 16, immediately know what attachment 30 is attached to the hitch 16.

In one or more preferred embodiments, the working vehicle 1 may further include an auxiliary mode switch 28 to be operated to start an auxiliary mode in which a specific attachment 30 is allowed to be used, a power outlet port (hydraulic fluid outlet port) 18a through which power is outputted to the specific attachment 30, and an auxiliary output switch 29 to be operated to transmit power to the power outlet port 18a. The controller 21 may be configured or programmed to, if the controller 21 determines that the attachment 30 attached to the hitch 16 is the specific attachment while the prime mover 9 is being actuated and the auxiliary mode is being performed, output power to the specific attachment 30 through the power outlet port 18a in response to operation of the auxiliary output switch 29, and when the prime mover 9 is stopped temporarily and then restarted with the attachment 30 attached to the hitch 16, if the result of identification of the attachment 30 stored in the second memory indicates the specific attachment, output, after the auxiliary mode is started in response to operation of the auxiliary mode switch 28, power to the specific attachment through the power outlet port 18 in response to operation of the auxiliary output switch 29.

With this, it is possible, when a specific attachment 30 is attached to the hitch 16 while the prime mover 9 is being actuated, to output power to the specific attachment 30 in response to the operation of the auxiliary output switch 29 to actuate the specific attachment 30 to perform corresponding work. It is also possible, when the prime mover 9 is restarted with the specific attachment 30 attached to the hitch 16, to output power to the specific attachment 30 to actuate the specific attachment 30 to perform corresponding work, in response to two operations: the operation of the auxiliary mode switch 28 and operation of the auxiliary output switch 29. It is also possible to eliminate or reduce the likelihood that, when an attachment 30 other than the specific attachment 30 is attached to the hitch 16 and the auxiliary output switch 29 is accidentally operated, power will be needlessly outputted to the attachment 30.

In one or more preferred embodiments, the controller 21 may be configured or programmed to, if the controller 21 determines that the attachment 30 is allowed to be detached from the hitch, delete the result of identification of the attachment 30 from the second memory. With this, it is possible to cause the second memory to store only the result of identification of the attachment 30 actually attached to the hitch 16, and also possible to eliminate or reduce the likelihood that an attachment 30 will be identified wrongly based on a result of identification stored in the second memory.

In one or more preferred embodiments, the working vehicle 1 may further include a third memory (nonvolatile memory 22, internal memory 21a) to store a first set period Tb1 which is equal to or longer than the first predetermined period Tb and a second set period Ta2 which is equal to or longer than the second predetermined period Ta. The controller 21 may be configured or programmed to, when the at least one operation switch (attaching switch 26, detaching switch 27) is operated continuously for the first set period Tb1 or more or for the second set period Ta2 or more, determine that the attachment 30 is allowed to be detached from the hitch 16 or is attached to the hitch 16 and start the predetermined process. With this, even if the time taken for the latch actuator 52 to switch the latching mechanism 51 from the latching state to the unlatching state differs from the time taken for the latch actuator 52 to switch the latching mechanism 51 from the unlatching state to the latching state, it is possible to reliably link the process to be performed when the working vehicle 1 is provided with the attachment 30 and the process to be performed when the working vehicle 1 is provided with no attachments 30 with the corresponding states, as intended by the operator who operates the operation switch.

In one or more preferred embodiments, the transmitter 33 may be a beacon transmitter to transmit an advertisement signal Q1 including identification information of the attachment 30 in or on which the transmitter 33 is provided. The receiver 23 may be a beacon scanner to receive the advertisement signal Q1. With this, it is possible to easily and immediately identify the attachment 30 attached to the hitch 16 of the working vehicle 1 using a versatile unidirectional communication from the beacon transmitter 33 to the beacon scanner 23.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A working vehicle comprising:
a hitch to attach and detach an attachment thereto and therefrom;
at least one operation switch to be operated to attach or detach the attachment to or from the hitch;
a receiver to receive a wireless signal which is transmitted periodically from a transmitter in or on the attachment, which includes identification information of the attachment, and which is compliant with a near field communication standard; and
a controller to perform a predetermined process based on the identification information included in the wireless signal received by the receiver, wherein
the hitch includes:
a latching mechanism operable selectively in a latching state in which the attachment is secured to the hitch and an unlatching state in which the attachment is not secured to the hitch; and
a latch actuator to actuate the latching mechanism between the latching state and the unlatching state while the at least one operation switch is being operated, and
the controller is configured or programmed to, when the at least one operation switch is operated continuously for a first predetermined period or more or for a second predetermined period or more, determine that the attachment is allowed to be detached from the hitch or is attached to the hitch and start the predetermined process, the first predetermined period being a period of time taken for the latching mechanism to switch from the latching state to the unlatching state, the second predetermined period being a period of time taken for the latching mechanism to switch from the unlatching state to the latching state.

2. The working vehicle according to claim 1, wherein
the at least one operation switch includes a detaching switch to be operated to allow the attachment to be detached from the hitch; and
the controller is configured or programmed to, when the detaching switch is operated continuously for the first predetermined period or more, determine that the attachment is allowed to be detached from the hitch and start a without-attachment predetermined process as the predetermined process, the without-attachment predetermined process being a process based on a precondition that the working vehicle is provided with no attachments.

3. The working vehicle according to claim 1, wherein
the at least one operation switch includes an attaching switch to be operated to attach the attachment to the hitch; and
the controller is configured or programmed to, when the attaching switch is operated continuously for the second predetermined period or more, determine that the attachment indicated by the identification information included in the wireless signal received by the receiver is attached to the hitch and start a with-attachment predetermined process as the predetermined process, the with-attachment predetermined process being a process based on a precondition that the working vehicle is provided with the attachment.

4. The working vehicle according to claim 2, wherein
the at least one operation switch includes an attaching switch to be operated to attach the attachment to the hitch; and
the controller is configured or programmed to, when the attaching switch is operated continuously for the second predetermined period or more, determine that the attachment indicated by the identification information included in the wireless signal received by the receiver is attached to the hitch and start a with-attachment predetermined process as the predetermined process, the with-attachment predetermined process being a process based on a precondition that the working vehicle is provided with the attachment.

5. The working vehicle according to claim 4, wherein
the controller is configured or programmed to, when the attachment is attached to the hitch and the controller is performing the with-attachment predetermined process, if the detaching switch is operated and a duration of operation of the detaching switch is less than the first predetermined period, continue to perform the with-attachment predetermined process or stop the with-attachment predetermined process temporarily and then resume the with-attachment predetermined process.

6. The working vehicle according to claim 3, wherein
the controller is configured or programmed to, when the attachment is attached to the hitch and the controller is performing the with-attachment predetermined process, if the attaching switch is operated, continue to perform the with-attachment predetermined process.

7. The working vehicle according to claim 4, wherein
the controller is configured or programmed to, when the attachment is attached to the hitch and the controller is performing the with-attachment predetermined process, if the detaching switch is operated continuously for the first predetermined period or more and then the attaching switch instead of the detaching switch starts to be operated within a third predetermined period and is operated continuously for the second predetermined period or more, continue to perform the with-attachment predetermined process or stop the with-attachment predetermined process temporarily and then resume the with-attachment predetermined process.

8. The working vehicle according to claim 4, wherein
the controller is configured or programmed to, if the attaching switch is operated continuously for the second predetermined period or more after the controller has determined that the attachment is allowed to be detached, read identification information included in a wireless signal received by the receiver after a fourth predetermined period after the controller has determined that the attachment is allowed to be detached and determine that an attachment indicated by the identification information is attached to the hitch.

9. The working vehicle according to claim 2, wherein
the controller is configured or programmed to perform, as the without-attachment predetermined process, a process to cause a user interface to output information indicating that the attachment is allowed to be detached.

10. The working vehicle according to claim 3, wherein
the controller is configured or programmed to perform, as the with-attachment predetermined process, a process to cause a user interface to output information indicating that the attachment is attached.

11. The working vehicle according to claim 3, further comprising a first memory to store one or more pieces of control data set for respective one or more of the attachments; wherein
the controller is configured or programmed to start, as the with-attachment predetermined process, a process including reading, from the first memory, one of the one or more pieces of control data that corresponds to one of the one or more attachments that is attached to the hitch and controlling output of power to the one of the one or more attachments based on the read one of the one or more pieces of control data.

12. The working vehicle according to claim 1, wherein
the at least one operation switch includes a detaching switch to be operated to allow the attachment to be detached from the hitch and an attaching switch to be operated to attach the attachment to the hitch; and
the controller is configured or programmed to:
when the detaching switch is operated continuously for the first predetermined period or more and a first actuation period has passed since a start of operation of the detaching switch, determine that the attachment is allowed to be detached from the hitch and start a without-attachment predetermined process as the predetermined process, the without-attachment predetermined process being a process based on a precondition that the working vehicle is provided with no attachments; and
when the attaching switch is operated continuously for the second predetermined period or more and a second actuation period has passed since a start of operation of the attaching switch, determine that the attachment is attached to the hitch and start a with-attachment predetermined process as the predetermined process, the with-attachment predetermined process being a process based on a precondition that the working vehicle is provided with the attachment.

13. The working vehicle according to claim 3, further comprising:
a prime mover; and
a second memory; wherein
the controller is configured or programmed to:
upon determining that the attachment is attached to the hitch, identify the attachment based on the identification information included in the wireless signal transmitted from the transmitter in or on the attachment and received by the receiver and cause the second memory to store a result of identification of the attachment; and
if the prime mover is temporarily stopped and then is restarted with the attachment attached to the hitch, start the with-attachment predetermined process corresponding to the result of identification of the attachment stored in the second memory.

14. The working vehicle according to claim 13, wherein
the controller is configured or programmed to, if the prime mover is temporarily stopped and then is restarted with the attachment attached to the hitch, cause a user interface to output the result of identification of the attachment stored in the second memory.

15. The working vehicle according to claim 13, further comprising:
an auxiliary mode switch to be operated to start an auxiliary mode in which a specific attachment is allowed to be used;
a power outlet port through which power is outputted to the specific attachment; and
an auxiliary output switch to be operated to transmit power to the power outlet port; wherein
the controller is configured or programmed to:
if the controller determines that the attachment attached to the hitch is the specific attachment while the prime mover is being actuated and the auxiliary mode is being performed, output power to the specific attachment through the power outlet port in response to operation of the auxiliary output switch; and
when the prime mover is stopped temporarily and then restarted with the attachment attached to the hitch, if the result of identification of the attachment stored in the second memory indicates the specific attachment, output, after the auxiliary mode is started in response to operation of the auxiliary mode switch, power to the specific attachment through the power outlet port in response to operation of the auxiliary output switch.

16. The working vehicle according to claim 13, wherein
the controller is configured or programmed to, if the controller determines that the attachment is allowed to be detached from the hitch, delete the result of identification of the attachment from the second memory.

17. The working vehicle according to claim 1, further comprising:
a third memory to store a first set period which is equal to or longer than the first predetermined period and a second set period which is equal to or longer than the second predetermined period; wherein
the controller is configured or programmed to, when the at least one operation switch is operated continuously for the first set period or more or for the second set period or more, determine that the attachment is allowed to be detached from the hitch or is attached to the hitch and start the predetermined process.

18. The working vehicle according to claim 1, wherein
the transmitter is a beacon transmitter to transmit an advertisement signal including identification information of the attachment in or on which the transmitter is provided; and
the receiver is a beacon scanner to receive the advertisement signal.

19. An attachment usage system comprising:
a hitch to attach and detach an attachment thereto and therefrom, the hitch being provided on a working vehicle;
at least one operation switch to be operated to attach or detach the attachment to or from the hitch;
a receiver to receive a wireless signal which is transmitted periodically from a transmitter in or on the attachment, which includes identification information of the attachment, and which is compliant with a near field communication standard; and
a controller to perform a predetermined process based on the identification information included in the wireless signal received by the receiver; wherein
the hitch includes:
a latching mechanism operable selectively in a latching state in which the attachment is secured to the hitch and an unlatching state in which the attachment is not secured to the hitch; and
a latch actuator to actuate the latching mechanism between the latching state and the unlatching state while the at least one operation switch is being operated; and
the controller is configured or programmed to, when the at least one operation switch is operated continuously for a first predetermined period or more or for a second predetermined period or more, determine that the attachment is allowed to be detached from the hitch or is attached to the hitch and start the predetermined process, the first predetermined period being a period of time taken for the latching mechanism to switch from the latching state to the unlatching state, the second predetermined period being a period of time taken for the latching mechanism to switch from the unlatching state to the latching state.
